(19) United States
(12) Patent Application Publication
(10) Pub. No.: US 2026/0073707 A1
(43) Pub. Date: Mar. 12, 2026

(54) ELECTRONIC DEVICE, METHOD AND NON-TRANSITORY COMPUTER READABLE STORAGE MEDIUM IDENTIFYING DIRECTION OF MOVEMENT OF EXTERNAL OBJECT

(71) Applicant: THINKWARE CORPORATION, Seongnam-si (KR)

(72) Inventors: Yosep Park, Seongnam-si (KR); Haejun Jung, Seongnam-si (KR); Dongwon Shin, Seongnam-si (KR)

(73) Assignee: THINKWARE CORPORATION, Seongnam-si (KR)

(21) Appl. No.: 19/317,394

(22) Filed: Sep. 3, 2025

(30) Foreign Application Priority Data
Sep. 11, 2024 (KR) 10-2024-0123916

(51) Int. Cl. G06V 20/58; G06T 7/20; G06T 7/50; G06V 10/26; G06V 10/82; G06V 20/56

(52) U.S. Cl. CPC G06V 20/58; G06T 7/20; G06T 7/50; G06V 10/26; G06V 10/82; G06V 20/588; G06T 2207/20084; G06T 2207/30256; G06V 2201/08

(57) ABSTRACT

An electronic device includes an image sensor, a CPU, an NPU, and memory including one or more storage media storing instructions. The instructions, when executed by the CPU, cause the electronic device to obtain, via the image sensor, an image, execute an object detection model configured to detect an external object from the image, by controlling the NPU, obtain, from the NPU, coordinate values indicating a portion of the image associated with the external object, perform a plurality of calculations defining a direction identification model configured to identify a direction of movement of the external object based on the coordinate values, by controlling processing circuitry of the CPU, and based on a direction of movement of the external object indicated by a result of the plurality of calculations, output a notification with respect to the direction of movement.

### TECHNICAL FIELD

The following descriptions relate to an electronic device, a method, and a non-transitory computer readable storage medium identifying a direction of movement of an external object.

### BACKGROUND ART

An electronic device may be equipped with a car. The electronic device may perform a function of an advanced driver assistance system (ADAS). The electronic device may prevent a traffic accident, using the advanced driver assistance system. For convenience and safety of a driver, the advanced driver assistance system is being studied.

The above-described information may be provided as a related art for the purpose of helping understanding of the present disclosure. No argument or decision is made as to whether any of the above description may be applied as a prior art related to the present disclosure.

### DISCLOSURE

### Technical Solution

An electronic device is provided. The electronic device may comprise an image sensor. The electronic device may comprise a central processing unit (CPU). The electronic device may comprise a neural processing unit (NPU). The electronic device may comprise memory comprising one or more storage media storing instructions. The instructions, when executed by the CPU, may cause the electronic device to obtain, via the image sensor, an image. The instructions, when executed by the CPU, may cause the electronic device to execute an object detection model configured to detect an external object from the image, by controlling the NPU. The instructions, when executed by the CPU, may cause the electronic device to obtain, from the NPU, coordinate values indicating a portion of the image associated with the external object. The instructions, when executed by the CPU, may cause the electronic device to perform a plurality of calculations defining a direction identification model configured to identify a direction of movement of the external object based on the coordinate values, by controlling processing circuitry of the CPU. The instructions, when executed by the CPU, may cause the electronic device to, based on a direction of movement of the external object indicated by a result of the plurality of calculations, output a notification with respect to the direction of movement.

A method is provided. The method may be executed within an electronic device with an image sensor, a CPU, and an NPU. The method may comprise obtaining, via the image sensor, an image. The method may comprise executing an object detection model configured to detect an external object from the image, by controlling the NPU. The method may comprise obtaining, from the NPU, coordinate values indicating a portion of the image associated with the external object. The method may comprise performing a plurality of calculations defining a direction identification model configured to identify a direction of movement of the external object based on the coordinate values, by controlling processing circuitry of the CPU. The method may comprise, based on a direction of movement of the external object indicated by a result of the plurality of calculations, outputting a notification with respect to the direction of movement.

A non-transitory computer readable storage medium is provided. The non-transitory computer readable storage medium may store one or more programs. The one or more programs may include instructions that, when executed by the electronic device with an image sensor, a CPU, and an NPU, cause the electronic device to obtain, via the image sensor, an image. The one or more programs may include instructions that, when executed by the electronic device, cause the electronic device to execute an object detection model configured to detect an external object from the image, by controlling the NPU. The one or more programs may include instructions that, when executed by the electronic device, cause the electronic device to obtain, from the NPU, coordinate values indicating a portion of the image associated with the external object. The one or more programs may include instructions that, when executed by the electronic device, cause the electronic device to perform a plurality of calculations defining a direction identification model configured to identify a direction of movement of the external object based on the coordinate values, by controlling processing circuitry of the CPU. The one or more programs may include instructions that, when executed by the electronic device, cause the electronic device to include, based on a direction of movement of the external object indicated by a result of the plurality of calculations, outputting a notification with respect to the direction of movement.

An electronic device is provided. The electronic device may comprise an image sensor. The electronic device may comprise a central processing unit (CPU). The electronic device may comprise a neural processing unit (NPU). The electronic device may comprise memory comprising one or more storage media storing instructions. The instructions, when executed by the CPU, may cause the electronic device to obtain, via the image sensor, an image. The instructions, when executed by the CPU, may cause the electronic device to execute an object detection model configured to detect an external object from the image, by controlling the NPU. The instructions, when executed by the CPU, may cause the electronic device to obtain, from the NPU, coordinate values indicating a portion of the image associated with the external object. The instructions, when executed by the CPU, may cause the electronic device to perform a plurality of calculations defining a direction identification model configured to identify a direction of movement of the external object based on the coordinate values, by controlling processing circuitry of the CPU. The instructions, when executed by the CPU, may cause the electronic device to, based on the coordinate values and a direction of movement of the external object indicated by a result of the plurality of calculations, output a notification with respect to a distance between a car equipped with the electronic device and the external object.

A method is provided. The method may be executed within an electronic device with an image sensor, a CPU, and an NPU. The method may comprise obtaining, via the image sensor, an image. The method may comprise executing an object detection model configured to detect an external object from the image, by controlling the NPU. The method may comprise obtaining, from the NPU, coordinate values indicating a portion of the image associated with the external object. The method may comprise performing a plurality of calculations defining a direction identification model configured to identify a direction of movement of the external object based on the coordinate values, by controlling processing circuitry of the CPU. The method may comprise, based on the coordinate values and a direction of movement of the external object indicated by a result of the plurality of calculations, outputting a notification with respect to a distance between a car equipped with the electronic device and the external object.

A non-transitory computer readable storage medium is provided. The non-transitory computer readable storage medium may store one or more programs. The one or more programs may include instructions that, when executed by the electronic device with an image sensor, a CPU, and an NPU, cause the electronic device to obtain, via the image sensor, an image. The one or more programs may include instructions that, when executed by the electronic device, cause the electronic device to execute an object detection model configured to detect an external object from the image, by controlling the NPU. The one or more programs may include instructions that, when executed by the electronic device, cause the electronic device to obtain, from the NPU, coordinate values indicating a portion of the image associated with the external object. The one or more programs may include instructions that, when executed by the electronic device, cause the electronic device to perform a plurality of calculations defining a direction identification model configured to identify a direction of movement of the external object based on the coordinate values, by controlling processing circuitry of the CPU. The one or more programs may comprise instructions that, when executed by the electronic device, cause the electronic device to, based on the coordinate values and a direction of movement of the external object indicated by a result of the plurality of calculations, output a notification with respect to a distance between a car equipped with the electronic device and the external object.

### DESCRIPTION OF THE DRAWINGS

FIG. 1 illustrates an example of an environment including a car equipped with an electronic device.

FIG. 2 is a simplified block diagram of an exemplary electronic device.

FIG. 3 illustrates an example of generating a notification with respect to a direction of movement of an external object using an NPU and a CPU.

FIGS. 4A and 4B illustrate an example of identifying an external object within an image using an object detection model.

FIG. 5 illustrates an example of identifying an area within an image using an image segmentation model.

FIG. 6 illustrates an example of selecting a portion of data received from an NPU such that a plurality of calculations of a direction identification model are performed within duration.

FIGS. 7A and 7B illustrate an example of calculating a distance between a car equipped with an electronic device and an external object using a direction of movement of the external object and coordinate values indicating a portion of an image associated with the external object.

FIG. 8 illustrates an example of an environment in which an electronic device outputs a notification based on a direction of movement of an external object.

FIGS. 9A and 9B illustrate an example of an operation performed by the electronic device in accordance with a notification.

FIG. 10 illustrates an example of a structure of an artificial intelligence model.

FIG. 11 illustrates an example of a block diagram illustrating an autonomous driving system of a vehicle according to an embodiment.

FIGS. 12 and 13 illustrate an example of a block diagram indicating an autonomous driving moving object according to an embodiment.

FIG. 14 illustrates an example of a gateway related to a user device according to various embodiments.

FIG. 15 is a diagram for explaining an operation of an electronic device for training a neural network based on a set of learning data, according to an embodiment.

FIG. 16 is a block diagram of an electronic device according to an embodiment.

It will be understood that the same reference numerals refer to the same part, component, and structure throughout drawings.

### MODE FOR INVENTION

Terms used in the present disclosure are used only to describe a specific embodiment, and may not be intended to limit a range of another embodiment. A singular expression may include a plural expression unless the context clearly means otherwise. Terms used herein, including a technical or a scientific term, may have the same meaning as those generally understood by a person with ordinary skill in the art described in the present disclosure. Among the terms used in the present disclosure, terms defined in a general dictionary may be interpreted as identical or similar meaning to the contextual meaning of the relevant technology and are not interpreted as ideal or excessively formal meaning unless explicitly defined in the present disclosure. In some cases, even terms defined in the present disclosure may not be interpreted to exclude embodiments of the present disclosure.

In various embodiments of the present disclosure described below, a hardware approach will be described as an example. However, since the various embodiments of the present disclosure include technology that uses both hardware and software, the various embodiments of the present disclosure do not exclude a software-based approach.

A term referring to data (e.g., data or information), a term referring to a value (e.g., a threshold), a term for a calculation state (e.g., an operation or a process), a term referring to an object (e.g., an external object), a term referring to network entities, a term referring to a component of a device, and the like are exemplified for convenience of description. Therefore, the present disclosure is not limited to terms to be described below, and another term having an equivalent technical meaning may be used. In addition, a term such as ‘ . . . unit’, ‘ . . . device’, ‘ . . . object’, and ‘ . . . structure’, and the like used below may mean at least one shape structure or may mean a unit processing a function.

In addition, in the present disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B). Hereinafter, ‘C’ and/or ‘D’ means including at least one of ‘C’ or ‘D’, that is, {‘C,’, ‘D’, and ‘C’ and ‘D’}.

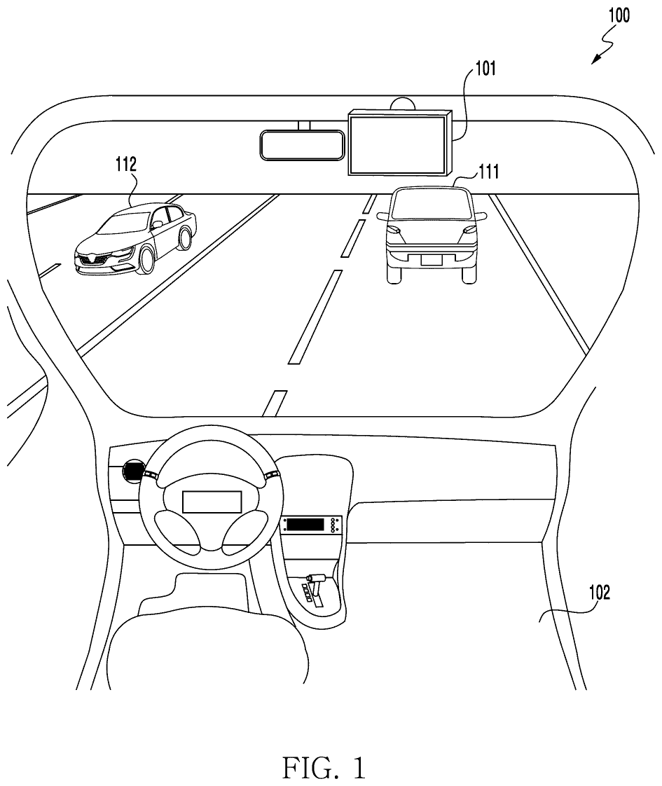

FIG. 1 illustrates an example of an environment including a car equipped with an electronic device.

Referring to FIG. 1, an environment 100 may include a car 102 equipped with an electronic device 101. A form in which the electronic device 101 is equipped with the car 102 indicated in FIG. 1 is only exemplary. For example, the electronic device 101 may be embedded in the a car 102. For example, the electronic device 101 may be built-in to the car 102.

For example, the electronic device 101 may be described as an image processing device for a car. For example, the electronic device 101 may include a dashboard camera and a navigation system. For example, the electronic device 101 may be implemented as various types of products such as a personal computer, a laptop, a tablet computer, a smartphone, a smart home appliance, an intelligent car, and a wearable device. However, it is not limited thereto.

For example, the electronic device 101 may include an image sensor. For example, the electronic device 101 may obtain an image via the image sensor. For example, the image obtained by the electronic device 101 may include an external object (e.g., an external object 111 or an external object 112). For example, the electronic device 101 may store the image obtained via the image sensor in memory of the electronic device 101.

For example, the car 102 may collide with the external object 112. For example, the electronic device 101 may perform a function of an advanced driver assistance system (ADAS) to prevent collision between the car 102 and the external object 112. For example, as calculation speed of the electronic device 101 is faster, quality of the function of the advanced driver assistance system may be higher. For example, the calculation speed of the electronic device 101 may increase as an amount of data load decreases.

For example, the electronic device 101 may identify (or determine) a direction of movement of the external object 112 to prevent the collision between the car 102 and the external object 112. For example, in order for the electronic device 101 to reduce the amount of the data load, a method of identifying the direction of movement of the external object 112 using a coordinate value of the external object 112 within an image may be required. For example, in the electronic device 101, a method of outputting a notification in accordance with a direction of movement of an external object may be required.

For example, the electronic device 101 may determine a probability of collision between the car 102 and the external object 111. For example, the electronic device 101 may calculate a distance between the car 102 and the external object 111 to determine the probability of collision. For example, for a relatively small amount of data load in the electronic device 101, a method of determining the distance between the car 102 and the external object 111 based on a coordinate value of the external object 111 within an image and a direction of movement of the external object 111 may be required.

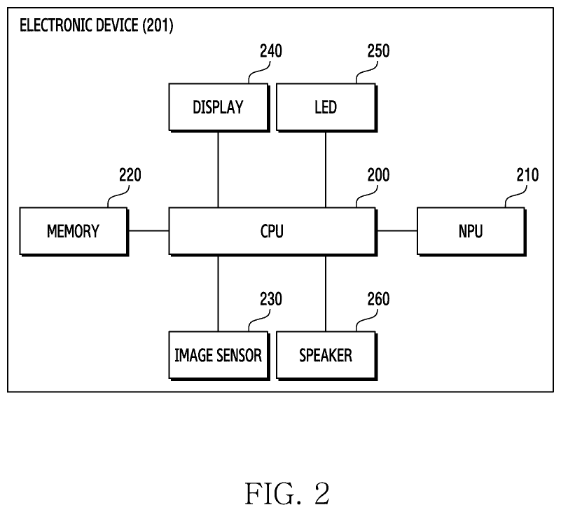

For example, this method may be executed in an electronic device to be described later. For example, the electronic device to be described later may include components (or hardware components) for providing this method. The components are described and exemplified in more detail with reference to FIG. 2.

FIG. 2 is a simplified block diagram of an exemplary electronic device.

Referring to FIG. 2, an electronic device 201 may include a central processing unit (CPU) 200, a neural processing unit (NPU) 210, memory 220, an image sensor 230, a display 240, a light emitting diode 250, and a speaker 260. For example, an electronic device 101 may be an example of the electronic device 201.

The CPU 200 may be indicated as a hardware component for processing data based on executing instructions. For example, the CPU 200 may include processing circuitry. The CPU 200 may include one or more cores. For example, the CPU 200 may have a structure of a multi-core processor such as a dual core, a quad core, or a hexa core.

The NPU 210 may be indicated as a hardware component for using artificial intelligence (AI) software. For example, the NPU 210 may include processing circuitry. For example, the NPU 210 may be usable for a machine learning algorithm computation and/or a deep learning algorithm computation. For example, the NPU 210 may be usable for executing a machine learning model and/or a deep learning model.

The memory 220 may include a hardware component for storing data and/or instructions inputted to the CPU 200 and/or outputted from the CPU 200. For example, the memory 220 may include, for example, volatile memory such as random-access memory (RAM) and/or non-volatile memory such as read-only memory (ROM). For example, the volatile memory may include, for example, at least one of dynamic RAM (DRAM), static RAM (SRAM), cache RAM, and pseudo SRAM (PSRAM). For example, the non-volatile memory may include, for example, at least one of programmable ROM (PROM), erasable PROM (EPROM), electrically erasable PROM (EEPROM), flash memory, a hard disk, a compact disk, and an embedded multimedia card (EMMC).

The image sensor 230 may include one or more optical sensors (e.g., a charged coupled device (CCD) sensor and a complementary metal oxide semiconductor (CMOS) sensor) generating an electrical signal indicating a color and/or brightness of light. A plurality of optical sensors included in the image sensor 230 may be disposed in a form of a 2 dimensional array. The image sensor 230 may generate an image including a plurality of pixels corresponding to light reaching the optical sensors of the 2 dimensional array, and arranged in 2 dimensions, by obtaining an electrical signal of each of the plurality of optical sensors substantially simultaneously. For example, photographic data captured using the image sensor 230 may mean one image obtained from the image sensor 230. For example, video data captured using the image sensor 230 may mean a sequence of a plurality of images obtained along a designated frame rate from the image sensor 230.

The display 240 may include a hardware component of the electronic device 201 used to display a screen. For example, the display 240 may include light emitting elements and circuitry (e.g., transistors) controlling the light emitting elements to emit light. For example, each of the light emitting elements may include an organic light emitting diode (OLED) or a micro LED. However, it is not limited thereto. For example, the display 240 may include a liquid crystal display (LCD).

The LED 250 may emit light. For example, the LED 250 may be controlled to emit the light by the CPU 200. For example, the LED 250 may emit blue light, green light, and/or red light. However, it is not limited thereto.

The speaker 260 may output an acoustic signal to the outside of the electronic device 201. For example, the speaker 260 may be used for a general purpose, such as multimedia playback or recording playback.

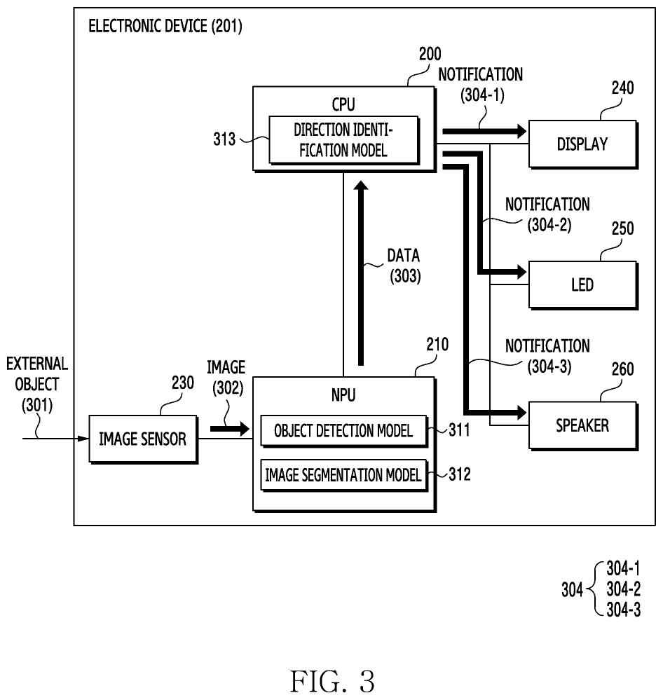

For example, the CPU 200 may execute instructions stored in the memory 220. For example, the instructions, when executed by the CPU 200, may cause to output a notification with respect to a direction of movement of an external object within an image obtained via the image sensor 230. These operations are described and exemplified in more detail with reference to FIGS. 3 to 10.

FIG. 3 illustrates an example of generating a notification with respect to a direction of movement of an external object using an NPU and a CPU. Contents to be described later are not limited to an image obtained via an image sensor. For example, the contents to be described later may also be applied to a video obtained via the image sensor. For example, an electronic device may be configured to determine, identify, and/or estimate the direction of movement of the external object for each of image frames included in the video.

Referring to FIG. 3, a CPU 200 may obtain an image 302 including an external object 301 via an image sensor 230. For example, the image 302 may indicate an image of a road including an external object 301. For example, the external object 301 may include a car. However, it is not limited thereto.

For example, the CPU 200 may control an NPU 210 to detect the external object 301 from the image 302. For example, the CPU 200 may execute an object detection model 311 by controlling the NPU 210. For example, the object detection model 311 may be indicated as a pre-trained model. For example, the object detection model 311 may be configured with a deep learning algorithm. For example, the object detection model 311 may be referred to as an object detection model. For example, the object detection model 311 may include a you only look once (YOLO) model.

For example, the CPU 200 may provide the image 302 to the object detection model 311 executed by the NPU 210. For example, providing the image 302 to the object detection model 311 may indicate inputting the image 302 to the object detection model 311. For example, the NPU 210 may detect the external object 301 within the image 302 using the object detection model 311. For example, the NPU 210 may identify the external object 301 within the image 302 using the object detection model 311.

For example, the NPU 210 may identify a portion of the image 302 associated with the external object 301 using the object detection model 311. For example, the NPU 210 may obtain coordinate values indicating the portion of the image 302 associated with the external object 301 using the object detection model 311. For example, the NPU 210 may obtain data 303 associated with the portion of the image 302 using the object detection model 311.

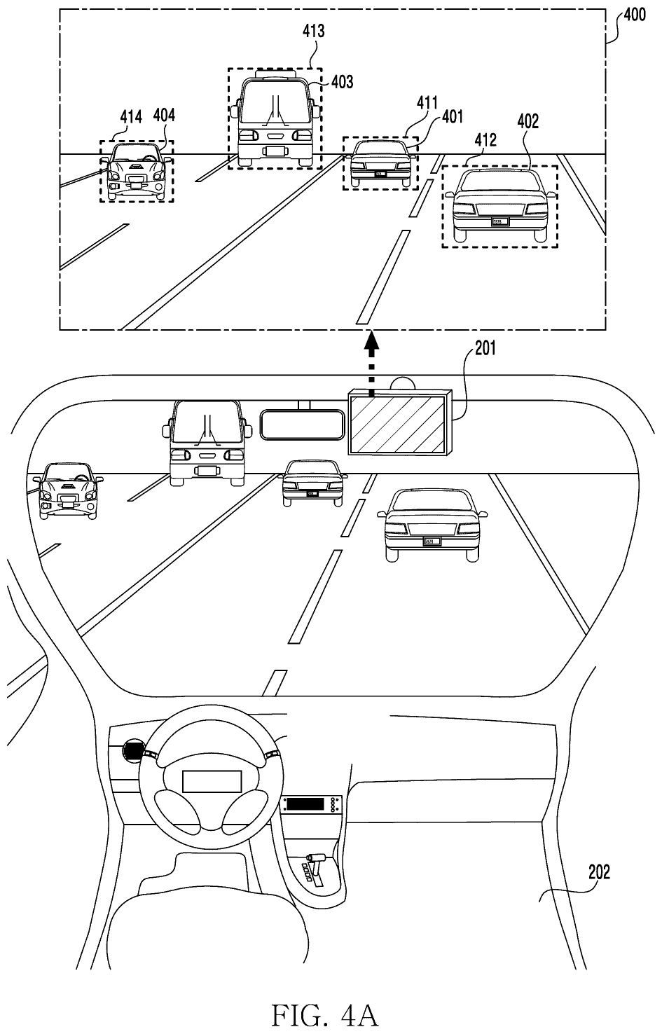

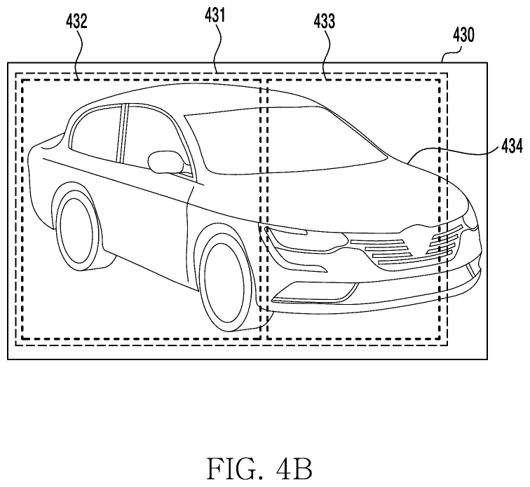

For example, an operation in which the NPU 210 identifies the portion of the image 302 associated with the external object 301 using the object detection model 311 is described and exemplified in more detail with reference to FIGS. 4A and 4B.

FIGS. 4A and 4B illustrate an example of identifying an external object within an image using an object detection model.

Referring to FIG. 4A, an electronic device 201 is equipped with a car 202. For example, a CPU 200 may obtain, via an image sensor 230, an image 302. For example, the CPU 200 may provide the image 302 to an object detection model 311 executed by an NPU 210. For example, the NPU 210 may obtain an image 400 using the object detection model 311.

For example, the image 400 includes an external object 401, an external object 402, an external object 403, and an external object 404. For example, the image 400 indicates a portion (e.g., a portion 411, a portion 412, a portion 413, or a portion 414) of the image 400 associated with an external object.

For example, the NPU 210 may identify the external object 401 within the image 400 using the object detection model 311. For example, the NPU 210 may identify a portion of the image 400 associated with the external object 401 using the object detection model 311. For example, the portion 411 of the image 400 associated with the external object 401 may be described as a quadrangular area surrounding the external object 401. A portion of an image indicated by FIG. 4A is illustrated as the quadrangular area, but this is only exemplary. As an example without limitation, a portion of the image may include a circular area, an elliptical area, and a triangular area.

For example, the NPU 210 may obtain data associated with the portion 411 using the object detection model 311. For example, the data associated with the portion 411 may include coordinate values indicating the portion 411. For example, the coordinate values may include a coordinate value of at least one vertex of the portion 411. For example, the coordinate value may include a coordinate value normalized using resolution of the image 400.

For example, the data associated with the portion 411 may include a value of a width of the portion 411 and a value of a height of the portion 411. For example, the value of the width of the portion 411 and the value of the height of the portion 411 may be normalized using the resolution of the image 400.

For example, the data associated with the portion 411 may include data on a type of the external object 401. For example, the type of the external object 401 may be referred to as a type of car. For example, the data on the type of the external object 401 may be indicated as a medium-sized car. However, it is not limited thereto.

For example, the type of the external object 401 and a type of the external object 402 may be indicated as the same type. For example, the external object 402 may be positioned closer to the car 202 than the external object 401. For example, a size of the portion 412 may be larger than a size of the portion 411. For example, a width of the portion 412 may be wider than a width of the portion 411.

For example, the size of the portion 411 may be calculated using data associated with the portion 411. For example, the CPU 200 may obtain the data associated with the portion 411 from the NPU 210. For example, the CPU 200 may calculate the size of the portion 411 by applying the value of the width of the portion 411 to the value of the height of the portion 411.

For example, in a case that a type of the external object is the same, as a size of a portion (e.g., the portion 412) is larger, a distance between an external object (e.g., the external object 402) associated with the portion and the car 202 may be shorter. For example, the distance between the car 202 and the external object is closer, a probability of collision may be higher. For example, as the distance between the car 202 and the external object is closer, importance of the external object may increase. For example, as a size of a portion associated with the external object increases, the CPU 200 may preferentially perform a plurality of calculations defining a direction identification model 313.

For example, since the size of the portion 412 is larger than the size of the portion 411, the CPU 200 may perform the plurality of calculations defining the direction identification model 313 using data associated with the portion 412 after performing the plurality of calculations defining the direction identification model 313 using the data associated with the portion 411.

For example, since the size of the portion 412 is larger than the size of the portion 411, the CPU 200 may perform the plurality of calculations defining the direction identification model 313 using the data associated with the portion 412 and refrain from (or bypass) performing the plurality of calculations defining the direction identification model 313 using the data associated with the portion 411.

For example, a type of the external object 403 may be indicated as a bus (or a large car). For example, the type of the external object 401 may be indicated as the medium-sized car. For example, the external object 403 may be positioned farther from the car 202 than the external object 401. For example, a size of the portion 413 may be larger than a size of the portion 411. For example, a case that the type of an external object is distinct may differ from a case that a type of an external object is the same. For example, in a case that the type of the external object is distinct, the size of the portion 413 is larger than the size of the portion 411, but a distance between the car 202 and the external object 403 may be longer than a distance between the car 202 and the external object 401.

For example, the CPU 200 may consider the type of the external object, in identifying the distance between the car 202 and the external object. For example, the CPU 200 may use a value corresponding to the size of the portion and the type of the external object, in identifying the distance between the car 202 and the external object.

For example, even though the size of the portion 413 is larger than the size of the portion 411, the CPU 200 may determine importance of the external object 403 to be lower than importance of the external object 401 based on the type of the external object 403 and the type of the external object 401. For example, the CPU 200 may perform a plurality of calculations defining the direction identification model 313 using data associated with the portion 413 after performing a plurality of calculations defining the direction identification model 313 using data associated with the portion 411.

For example, since the importance of the external object 401 is higher than the importance of the external object 403, the CPU 200 may perform the plurality of calculations defining the direction identification model 313 using the data associated with the portion 411 and refrain from (or bypass) performing the plurality of calculations defining the direction identification model 313 using the data associated with the portion 413.

Referring to FIG. 4B, the CPU 200 may obtain, via the image sensor 230, the image 302. For example, the NPU 210 may obtain an image 430 by providing the image 302 to the object detection model 311. For example, the image 430 may include a portion 431 of the image 430 associated with an external object 434. For example, the portion 431 may be described as an area within the image 430 including the external object 434. For example, the image 430 may include a portion 432 and a portion 433 within the portion 431. For example, the portion 432 may be indicated as a portion of the image 430 associated with a lateral surface of the external object 434. For example, the portion 433 may be indicated as a portion of the image 430 associated with a front surface of the external object 434. The portion 433 indicated by FIG. 4B is only exemplary. For example, the portion 433 may be indicated as a portion of an image associated with a rear surface of the external object 434.

For example, the NPU 210 may obtain data of a portion associated with the external object 434 using the object detection model 311. For example, the data of the portion associated with the external object 434 may include a coordinate value indicating the portion 432. For example, the coordinate value indicating the portion 432 may include a coordinate value of at least one vertex of the portion 432. For example, the coordinate value indicating the portion 432 may include a coordinate value normalized using a width value of the portion 431.

For example, the data of the portion associated with the external object 434 may include a value of a width of the portion 432 and a value of a height of the portion 432. For example, the value of the width of the portion 432 and the value of the height of the portion 432 may be normalized using the width value of the portion 431.

For example, the data of the portion associated with the external object 434 may include a coordinate value indicating the portion 433. For example, the coordinate value indicating the portion 433 may include a coordinate value of at least one vertex of the portion 433. For example, the coordinate value indicating the portion 433 may include a coordinate value normalized using the width value of the portion 431.

For example, the data of the portion associated with the external object 434 may include a value of a width of the portion 431 and a value of a height of the portion 431. For example, the value of the width of the portion 431 and the value of the height of the portion 431 may be normalized using the width value of the portion 431.

For example, the data 303 of FIG. 3 may include the data of the portion associated with the external object 434.

Referring back to FIG. 3, the CPU 200 may control the NPU 210 to perform image segmentation on the image 302. For example, the image segmentation may be described as identifying an area occupied by the external object 301 within the image 302. For example, the NPU 210 may identify pixels corresponding to the area occupied by the external object 301 within the image 302 by performing the image segmentation on the image 302. For example, the image segmentation may include identifying an area divided by a line within the image 302. For example, the NPU 210 may identify the pixels corresponding to the area divided by the line within the image 302 by performing the image segmentation on the image 302.

For example, the CPU 200 may execute an image segmentation model 312 by controlling the NPU 210. For example, the image segmentation model 312 may be indicated as a pre-trained model. For example, the image segmentation model 312 may be configured with a deep learning algorithm. For example, the image segmentation model 312 may be referred to as an image segmentation model.

For example, the CPU 200 may provide the image 302 to the image segmentation model 312 executed by the NPU 210. For example, providing the image 302 to the image segmentation model 312 may be indicated as inputting the image 302 to the image segmentation model 312. For example, the NPU 210 may identify the area occupied by the external object 301 within the image 302 using the image segmentation model 312.

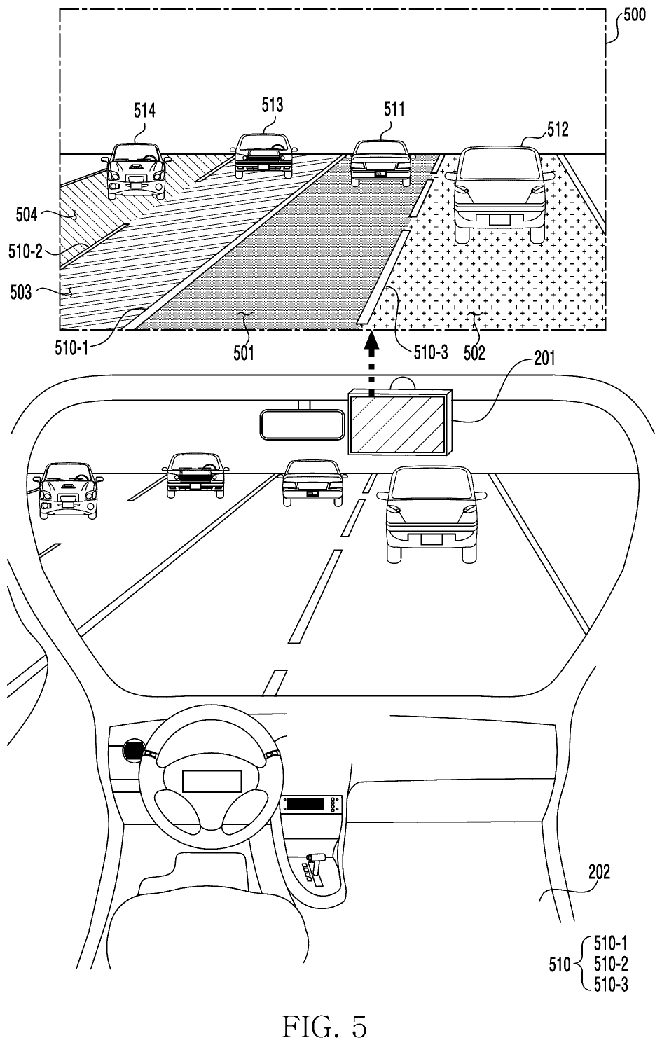

For example, an operation in which the NPU 210 identifies the area occupied by the external object 301 within the image 302 using the image segmentation model 312 is described and exemplified in more detail with reference to FIG. 5.

FIG. 5 illustrates an example of identifying an area within an image using an image segmentation model.

Referring to FIG. 5, a CPU 200 may provide an image 302 to an image segmentation model 312 executed by an NPU 210. For example, the NPU 210 may obtain an image 500 using the image segmentation model 312.

For example, the image 500 may be described as an image including a road. For example, the image 500 may include an external object 511, an external object 512, an external object 513, and an external object 514. For example, the image 500 may include a line 510 within the load. For example, the NPU 210 may recognize the road within the image 500 using the image segmentation model 312. For example, the NPU 210 may recognize an area corresponding to a road divided by a central line 510-1, using the image segmentation model 312.

For example, the NPU 210 may recognize a lane within the image 500 using the image segmentation model 312. For example, the image segmentation model 312 may be configured to recognize the lane on which a car 202 is positioned. For example, the NPU 210 may identify an area corresponding to a lane divided by lanes 510-2, and 510-3, using the image segmentation model 312. For example, the NPU 210 may identify an area 501, an area 502, an area 503, and an area 504.

For example, the area 501 may be indicated as an area corresponding to the lane on which the car 202 is positioned. For example, since the area 501 corresponds to the lane in which the car 202 is driving, importance of the external object 511 in the area 501 may be higher than importance of another external object (e.g., the external object 512, the external object 513, and the external object 514).

For example, the CPU 200 may perform a plurality of calculations defining a direction identification model 313 using data associated with another external object (e.g., the external object 512, the external object 513, and the external object 514) after performing the plurality of calculations defining the direction identification model 313 using data associated with the external object 511.

For example, the CPU 200 may perform the plurality of calculations defining the direction identification model 313 using the data associated with the external object 511, and refrain from (or bypass) performing the plurality of calculations defining the direction identification model 313 using the data associated with the other external object (e.g., the external object 512, the external object 513, and the external object 514).

For example, the NPU 210 may divide the road within the image 500 by the central line 510-1. For example, the NPU 210 may identify a first area (e.g., including the area 503 and the area 504) corresponding to a road divided by the center line 510-1 and where the car 202 is not positioned, and a second area (e.g., including the area 501 and the area 502) corresponding to a road divided by the center line 510-1 and where the car 202 is positioned. For example, importance of an external object (e.g., the external object 513 and the external object 514) within the first area may be lower than importance of an external object (e.g., the external object 511 and the external object 512) within the second area.

For example, the CPU 200 may perform the plurality of calculations defining the direction identification model 313 using data associated with the external object (e.g., the external object 511 and the external object 512) within the second area, and refrain from (or bypass) performing the plurality of calculations defining the direction identification model 313 using data associated with the external object (e.g., the external object 513, and the external object 514, and the external object 514) within the first area.

Referring back to FIG. 3, the CPU 200 may obtain the data 303 from the NPU 210. For example, the data 303 may include data associated with a portion of the image 302 exemplified in FIG. 4A. For example, the data 303 may include data of a portion associated with the external object 301 within the image 302 exemplified in FIG. 4B. For example, the data 303 may include data of the image 302 on which the image segmentation exemplified in FIG. 5 is performed.

For example, the CPU 200 may execute the direction identification model 313 by controlling processing circuitry of the CPU 200. For example, the direction identification model 313 may be configured to identify a direction of movement of the external object 301. For example, the direction identification model 313 may output a notification with respect to the direction of movement of the external object 301 as the plurality of calculations defining the direction identification model 313 are performed. For example, the CPU 200 may perform the plurality of calculations defining the direction identification model 313 based on the data 303.

For example, CPU 200 may obtain movement direction information of the external object 301 by providing the data 303 to the direction identification model 313. For example, the movement direction information of the external object 301 may indicate the direction of movement of the external object 301 as an angle.

For example, the movement direction information of the external object 301 may be indicated as a value of applying a periodic function to a movement direction angle of the external object 301. For example, the periodic function may include a trigonometric function. For example, the periodic function may include a periodic function in a form of repeating that an output value increases linearly from −1 to 1 and decreases linearly from 1 to −1 as an input value increases. For example, a value of applying the periodic function to the movement direction angle of the external object 301 may indicate similarity of the movement direction angle, since it has a value between −1 and 1 and has a relatively small difference for a substantially adjacent angle (e.g., 359° and 1°, which have a difference of 2°).

For example, the CPU 200 may calculate the movement direction angle by applying a value of applying the trigonometric function to the movement direction angle of the external object 301 to an inverse function of the trigonometric function. For example, the CPU 200 may use the data 303 of a portion of an image associated with the external object 301 when calculating the movement direction angle. For example, the data 303 of the portion of the image associated with the external object 301 may indicate whether the portion of the image associated with the external object 301 includes a right surface or includes a left surface of the external object 301. For example, in a case that the portion of the image associated with the external object 301 includes the right surface of the external object 301 and in a case that the portion of the image associated with the external object 301 includes the left surface of the external object 301, the value of applying the trigonometric function to the movement direction angle is the same, but the movement direction angle may be different. For example, in a case that the portion of the image associated with the external object 301 includes the right surface of the external object 301, a value of applying a cosine function to the direction of movement is 0.5, but the direction of movement of the external object 301 may be 60°. For example, in a case that the portion of the image associated with the external object 301 includes the left surface of the external object 301, a value of applying the cosine function applied to the movement direction is 0.5, but the movement direction of the external object 301 may be 300°. For example, when calculating the movement direction angle, the CPU 200 may more accurately calculate the movement direction angle of the external object 301 by using the data 303 of the portion of the image associated with the external object 301.

For example, the CPU 200 may determine a probability of collision between the external object 301 and a car equipped with an electronic device 201, based on the movement direction information of the external object 301. For example, the CPU 200 may output a notification 304 based on the probability of collision. For example, the CPU 200 may output the notification 304 as the probability of the collision is greater than a threshold preset by the user. For example, the notification 304 may include the probability of collision between the external object 301 and the car equipped with the electronic device 201.

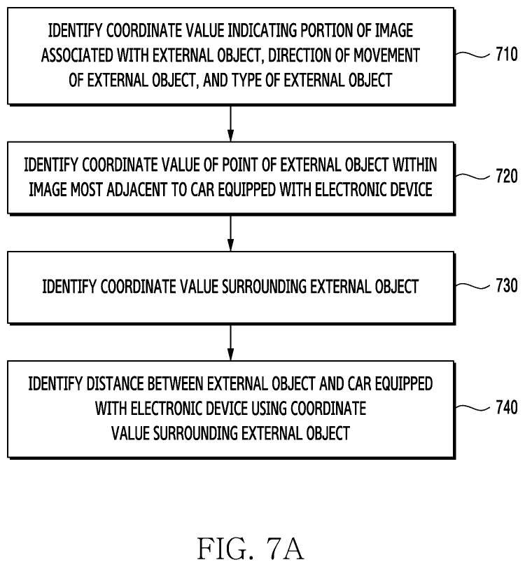

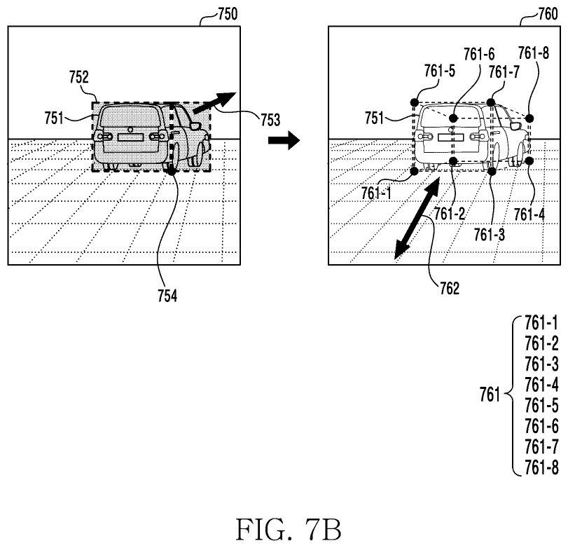

For example, the CPU 200 may output distance information between the car equipped with the electronic device 201 and the external object 301 based on the movement direction information of the external object 301 and the data 303. For example, the CPU 200 may determine the probability of collision between the external object 301 and the car 202 using the distance information and the direction of movement of the external object 301. For example, the distance information may be included in the notification 304. For example, a method of outputting the distance information between the car equipped with the electronic device 201 and the external object 301 using the movement direction information of the external object 301 and the data 303 will be described and exemplified in more detail with reference to FIGS. 7A to 7B.

For example, the CPU 200 may determine the probability of collision between the external object 301 and the car equipped with the electronic device 201 using the distance information, the movement direction information of the external object 301, and the data 303. For example, the CPU 200 may output the notification 304 based on the probability of collision. For example, the notification 304 may include the probability of collision between the external object 301 and the car equipped with the electronic device 201.

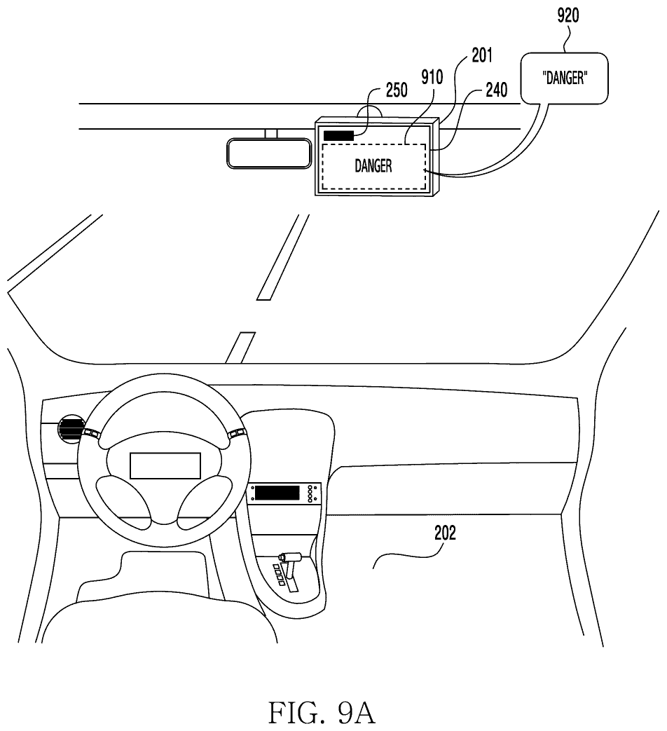

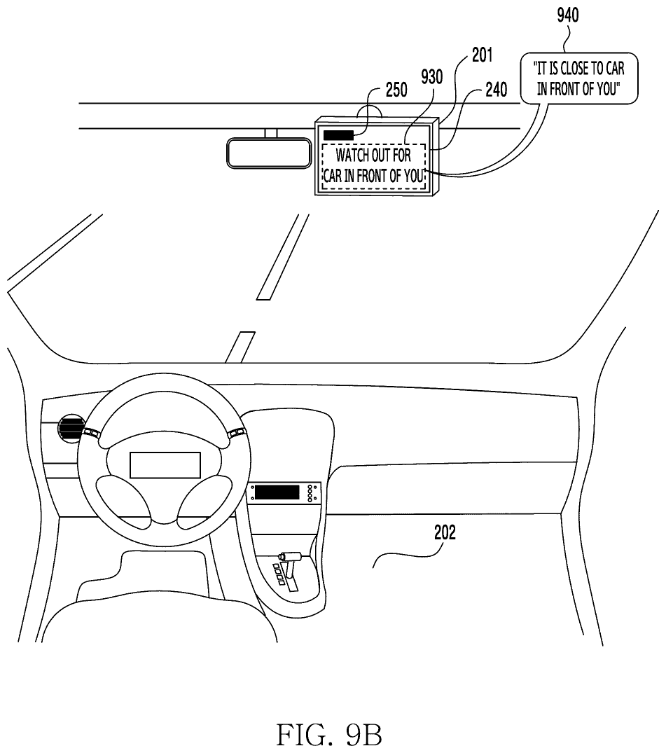

For example, the CPU 200 may transmit the notification 304 to a display 240, a LED 250, and/or a speaker 260. For example, an operation of the display 240, the LED 250, and/or the speaker 260 by the notification 304 of the CPU 200 will describe and exemplify in more detail with reference to FIGS. 9A and 9B.

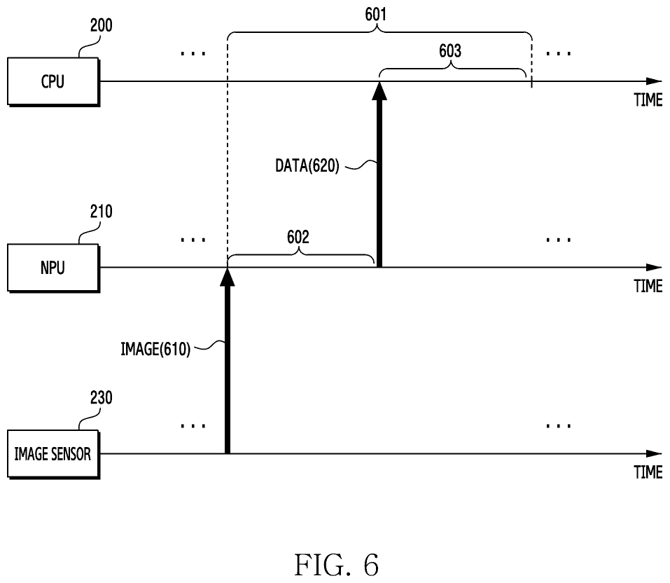

FIG. 6 illustrates an example of selecting a portion of data received from an NPU such that a plurality of calculations of a direction identification model are performed within duration.

Referring to FIG. 6, an NPU 210 may obtain, via an image sensor 230, an image 610. For example, the NPU 210 may obtain data 620 by providing the image 610 to an object detection model 311. For example, a CPU 200 may obtain the data 620 from the NPU 210. For example, the data 620 may be indicate as data outputted by providing the image 610 to the object detection model 311.

For example, the image 610 may include a plurality of external objects. For example, the data 620 may include data associated with the plurality of external objects within the image 610. For example, the data 620 may include data associated with a portion within the image 610 respectively associated with the plurality of external objects within the image 610.

For example, the CPU 200 may obtain duration 601 based on a result of a plurality of calculations of a direction identification model 313. For example, the duration 601 may be described as time required for the plurality of calculations to be performed by processing circuitry of the CPU 200. For example, the CPU 200 may calculate the duration 601 using another image obtained before obtaining the image 610. For example, the duration 601 may be preset by a user of an electronic device 201. For example, the duration 601 may be indicated as duration between a time point when the NPU 210 obtains the other image via the image sensor 230 and a time point when the CPU 200 outputs a notification 304 based on the other image.

For example, duration 602 may be described as time required for the CPU 200 to perform image processing with respect to the image 610 by controlling the NPU 210. For example, the duration 602 may be indicated as duration between the time point when the NPU 210 obtains the other image via the image sensor 230 and a time point when the NPU 210 obtains the data 620 by providing the image 610 to the object detection model 311.

For example, duration 603 may be indicated as duration between a time point when the CPU 200 obtains the data 620 from the NPU 210 and a time point when the CPU 200 outputs the notification 304 by providing the data 620 to the direction identification model 313. For example, since the duration 601 is fixed, duration 603 may be the shorter as the duration 602 is longer.

For example, since the notification 304 should be outputted within the duration 603, the CPU 200 may select a portion of the data 620 in a case that an amount of the data 620 received from the NPU 210 is greater than an amount of data that may be processed within the duration 603. For example, the CPU 200 may select the portion of the data 620 such that the plurality of calculations of the direction identification model 313 are performed within the duration 603.

For example, the CPU 200 may determine an amount of data that the direction identification model 313 may process within the duration 603 such that the plurality of calculations of the direction identification model 313 are performed within the duration 603. For example, the CPU 200 may determine the number of portions of an image respectively associated with a plurality of external objects that the direction identification model 313 may process within the duration 603.

For example, the CPU 200 may identify whether the number of portions within the image 610 respectively associated with the plurality of external objects within the image 610 is greater than the determined number. For example, the CPU 200 may select a portion of the data 620 as it is determined that the number of the portions within the image 610 respectively associated with the plurality of external objects within the image 610 is greater than the determined number.

For example, the CPU 200 may select portions to be used to perform the plurality of calculations of the direction identification model 313 from among the portions within the image 610 respectively associated with the plurality of external objects within image 610. For example, the CPU 200 may select, among the portions within the image 610, the portions to be used to perform the plurality of calculations of the direction identification model 313, based on sizes of each of the portions within the image 610. For example, as a size of a portion of the image 610 is larger, a priority may be higher.

For example, the CPU 200 may select, from among the portions within the image 610 respectively associated with the plurality of external objects, the portions to be used to perform the plurality of calculations of the direction identification model 313 based on the sizes of each of the portions within the image 610 and a type of an external object.

For example, the CPU 200 may increase calculation speed by selecting the portion of the data 620 on which the plurality of calculations of the direction identification model 313 are to be performed.

FIGS. 7A and 7B illustrate an example of calculating a distance between a car equipped with an electronic device and an external object using a direction of movement of the external object and coordinate values indicating a portion of an image associated with the external object.

Referring to FIGS. 7A and 7B, in an operation 710, a CPU 200 may identify a coordinate value indicating a portion 752 of an image 750 associated with an external object 751, a direction of movement 753 of the external object 751, and a type of the external object 751 by performing the operations exemplified in FIG. 3.

For example, in an operation 720, the CPU 200 may identify a point 754 of the external object 751 within the image 750 most adjacent to a car 202, using the coordinate value indicating the portion 752 and the direction of movement 753 of the external object 751. For example, the CPU 200 may identify a coordinate value of the point 754. For example, the CPU 200 may identify a boundary of a bounding box corresponding to a lateral surface of the external object 751 and a bounding box corresponding to a rear surface (or a front surface) of the external object 751. For example, the point 754 may be indicated within the boundary. For example, the point 754 may include a point in contact with the boundary and the ground within the image 750.

For example, in an operation 730, the CPU 200 may identify points 761, and 761-1 to 761-8 surrounding the external object 751 within an image 760, based on the point 754 and the type of the external object 751. For example, the CPU 200 may identify a horizontal length of the external object 751, a vertical length of the external object 751, and a height of the external object 751, using the type of external object 751. For example, the CPU 200 may identify the points 761 surrounding the external object 751, using the coordinate value of the point 754, the direction of movement 753, the horizontal length of the external object 751, the vertical length of the external object 751, and the height of the external object 751. For example, the CPU 200 may identify a coordinate value of each of the points 761.

For example, in an operation 740, the CPU 200 may calculate a distance 762 between the car 202 and the external object 751 using the coordinate values 761 and 761-1 to 761-8 of each of the points 761. For example, the CPU 200 may identify the distance 762 between the car 202 and the external object 751 using the coordinate value of each of the points 761.

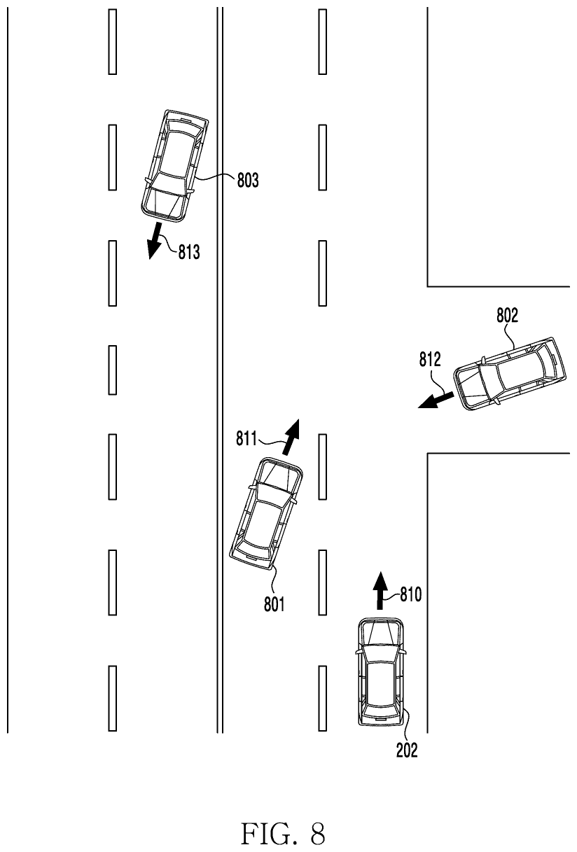

FIG. 8 illustrates an example of an environment in which an electronic device outputs a notification based on a direction of movement of an external object.

Referring to FIG. 8, an electronic device 201 may be equipped with a car 202. For example, it may be indicated that the car 202 is driving in a direction of movement 810. For example, it may be indicated that a car 801 is driving in a direction of movement 811. For example, it may be described that the car 801 is driving on a lane adjacent to a lane on which the car 202 is driving.

For example, a CPU 200 may identify the direction of movement 811 of the car 801 by performing the operations exemplified in FIG. 3. For example, the CPU 200 may determine a probability of collision between the car 202 and the car 801 based on the direction of movement 810 and the direction of movement 811. For example, the CPU 200 may output a notification 304 in accordance with the probability of collision. For example, the CPU 200 may output the notification 304 as the probability of the collision is greater than a threshold preset by a user. For example, a driver of the car 202 may prevent a collision accident by recognizing an operation performed by the electronic device 201 in accordance with the notification 304.

For example, the CPU 200 may determine the probability of collision between the car 202 and the car 801 based on a distance between the car 202 and the car 801, the direction of movement 810, and the direction of movement 811. For example, the driver of the car 202 may prevent the collision accident by recognizing the operation performed by the electronic device 201 in accordance with the notification 304 of the CPU 200. For example, the operation performed by the electronic device 201 in accordance with the notification 304 will be described and exemplified in more detail with reference to FIGS. 9A and 9B.

For example, a car 802 may be described as a car entering an intersection. For example, it may be indicated that the car 802 is driving in a direction of movement 812. For example, the CPU 200 may identify the direction of movement 812 of the car 802. For example, the CPU 200 may determine a probability of collision between the car 202 and the car 802 based on the direction of movement 810 and the direction of movement 812. For example, a driving route of the car 802 predicted in accordance with the direction of movement 812 and a driving route of the car 202 predicted in accordance with the direction of movement 810 may overlap. For example, the CPU 200 may identify that the probability of collision between the car 202 and the car 802 is greater than the threshold. For example, the CPU 200 may output the notification 304 with respect to the car 802.

For example, a car 803 may be described as a car driving on an opposite road divided by a center line. For example, it may be indicated that the car 803 is driving in a direction of movement 813. For example, the CPU 200 may identify the direction of movement 813 of the car 803. For example, the CPU 200 may determine a probability of collision between the car 202 and the car 803 based on the direction of movement 810 and the direction of movement 813. For example, a driving route of the car 803 predicted in accordance with the direction of movement 813 and a driving route of the car 202 predicted in accordance with the direction of movement 810 may not overlap. For example, the CPU 200 may identify that the probability of collision between the car 202 and a car 803 is less than the threshold. For example, the CPU 200 may refrain from outputting the notification 304 with respect to the car 803.

For example, the electronic device 201 may cause the driver of the car equipped with the electronic device 201 to prevent the collision accident by performing the above-described operations. For example, in the above-described operations, since a direction identification model 313 within the CPU 200 processes data 303 of an image 302 processed by an NPU 210, calculation speed of the electronic device 201 may be higher compared to performance of the electronic device 201.

FIGS. 9A and 9B illustrate an example of an operation performed by the electronic device in accordance with a notification.

Referring to FIG. 9A, it may be described that a CPU 200 outputs a notification 304 based on a direction of movement of an external object 301. For example, the CPU 200 may transmit the notification 304 to a display 240, a LED 250, and/or a speaker 260. For example, the notification 304 may include a probability of collision between the external object 301 and a car 202 equipped with an electronic device 201.

For example, the CPU 200 may transmit a notification 304-1 to the display 240. For example, the CPU 200 may display a screen 910 via the display 240 based on the probability of collision between the external object 301 and the car 202 equipped with the electronic device 201 being greater than a threshold preset by a user. For example, the screen 910 may include a content that warns a driver of a collision risk. For example, the screen 910 may include text notifying danger.

For example, the CPU 200 may transmit a notification 304-2 to the LED 250. For example, the CPU 200 may control the LED 250 to emit light based on the probability of collision between the external object 301 and the car 202 equipped with the electronic device 201 being greater than the threshold preset by the user. For example, the CPU 200 may control the LED 250 to use higher illumination light as the probability of collision between the external object 301 and the car 202 equipped with the electronic device 201 increases.

For example, the CPU 200 may control the LED 250 to blink light. For example, the CPU 200 may control the LED 250 such that the number (or a period) of light blinking per hour becomes higher as the probability of collision between external object 301 and the car 202 equipped with electronic device 201 increases.

For example, the CPU 200 may control the LED 250 to emit light of a different color. For example, the LED 250 may emit blue light, green light, and/or red light. For example, the CPU 200 may control the LED 250 to emit the light of the different color in accordance with the probability of collision between the external object 301 and the car 202 equipped with the electronic device 201. For example, the CPU 200 may control the LED 250 to emit the green light in a case that the probability of collision is less than 0.2. For example, the CPU 200 may control the LED 250 to emit the blue light in a case that the probability of the collision is greater than 0.2 and less than 0.4. For example, the CPU 200 may control LED 250 to emit the red light in a case that the probability of collision is greater than 0.4. However, it is not limited thereto.

For example, the CPU 200 may transmit a notification 304-3 to the speaker 260. For example, the CPU 200 may control the speaker 260 to output an audio notification 920 based on the probability of collision between the external object 301 and the car 202 equipped with the electronic device 201 being greater than the threshold preset by the user. For example, the audio notification 920 may include “danger”. However, it is not limited thereto. For example, in a case of the audio notification 920, a volume of the audio notification 920 may increase as the probability of collision between the external object 301 and the car 202 equipped with the electronic device 201 increases.

Referring to FIG. 9B, the CPU 200 may output distance information between the external object 301 and the car 202 based on the direction of movement of the external object 301 and data 303. For example, the CPU 200 may determine the probability of collision between the external object 301 and the car 202 using the distance information and the direction of movement of the external object 301. For example, in FIG. 9B, the CPU 200 may be described as outputting the notification 304 including the probability of collision between the external object 301 and the car 202. For example, the notification 304 may include the distance information between the external object 301 and the car 202.

For example, the CPU 200 may transmit the notification 304-1 to the display 240. For example, the CPU 200 may display a screen 930 via the display 240 based on the probability of collision between the external object 301 and the car 202 equipped with the electronic device 201 is greater than the threshold preset by the user. For example, the screen 930 may include a content that requests attention from the driver. For example, the screen 930 may include text indicating presence of the external object 301. However, it is not limited thereto. For example, the screen 930 may include text indicating a distance between the external object 301 and the car 202.

For example, the CPU 200 may transmit the notification 304-2 to the LED 250. For example, the CPU 200 may control the LED 250 to emit the light based on the probability of collision between the external object 301 and the car 202 equipped with the electronic device 201 is greater than the threshold preset by the user. For example, the CPU 200 may control the LED 250 to use higher illumination light as the probability of collision between the external object 301 and the car 202 equipped with the electronic device 201 increases. For example, the CPU 200 may control the LED 250 to blink the light. For example, the CPU 200 may control the LED 250 such that the number of light blinking per hour becomes higher as the probability of collision between the external object 301 and the car 202 equipped with the electronic device 201 increases.

For example, the CPU 200 may transmit the notification 304-3 to the speaker 260. For example, the CPU 200 may control the speaker 260 to output an audio notification 940 based on the probability of collision between the external object 301 and the car 202 equipped with the electronic device 201 is greater than the threshold preset by the user. For example, the audio notification 940 may include, “It is close to the car in front of you.”. However, it is not limited thereto. For example, in a case of the audio notification 940, a volume of the audio notification 940 may increase as the probability of collision between the external object 301 and the car 202 equipped with the electronic device 201 increases.

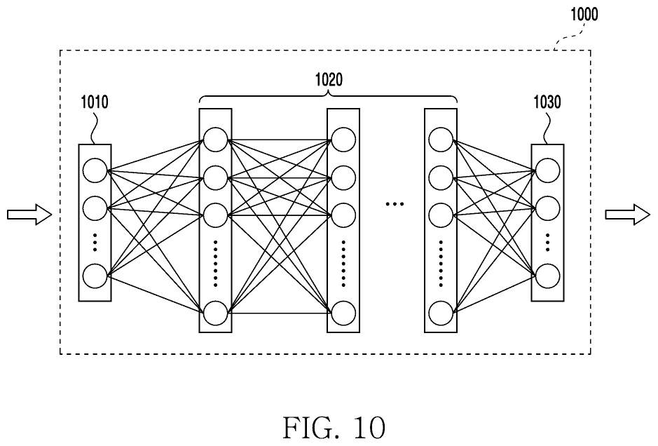

FIG. 10 illustrates an example of a structure of an artificial intelligence model.

Referring to FIG. 10, an example of a model 1000 indicated by a set of parameters stored within memory 220 of an electronic device 201 may be indicated. For example, an object detection model 311, an image segmentation model 312, and a direction identification model 313 may be an example of the model 1000.

At least a portion of the model 1000 may include a plurality of layers. For example, the model 1000 may include an input layer 1010, one or more hidden layers 1020, and an output layer 1030. The input layer 1010 may receive a vector (e.g., a vector with elements corresponding to the number of nodes included in the input layer 1010) indicating input data. Signals generated from each of the nodes within the input layer 1010 generated by the input data, may be transmitted from the input layer 1010 to the hidden layers 1020. The output layer 1030 may generate output data of the model 1000 based on one or more signals received from the hidden layers 1020. For example, the output data may include a vector with elements corresponding to the number of nodes included in the output layer 1030.

Referring to FIG. 10, the one or more hidden layers 1020 may be positioned between the input layer 1010 and the output layer 1030, and may convert the input data transmitted via the input layer 1010 into a value that is easy to predict. The input layer 1010, the one or more hidden layers 1020, and the output layer 1030 may include a plurality of nodes. The one or more hidden layers 1020 are not limited to illustrated feedforward-based topology, and may be, for example, a convolution filter in a convolutional neural network (CNN) or a fully connected layer, or various types of filters or layers bound based on a special function or feature. In an embodiment, the one or more hidden layers 1020 may be a layer based on a recurrent neural network (RNN) in which an output value is inputted back to a hidden layer of a current time. As an example, the input layer 1010, the one or more hidden layers 1020, and/or the output layer 1030 may be a partial layer of a transformer model. According to an embodiment, the model 1000 may form a deep neural network, by including the numerous hidden layers 1020. Learning the deep neural network is referred to as deep learning. From among nodes of the model 1000, a node included in the hidden layers 1020 is referred to as a hidden node.

Nodes included in the input layer 1010 and the one or more hidden layers 1020 may be connected to each other via a connection line with a connection weight, and nodes included in the hidden layer and the output layer may also be connected to each other via a connection line with a connection weight. Tuning and/or training the model 1000 may mean changing a connection weight between nodes included in each of the layers (e.g., the input layer 1010, the one or more hidden layers 1020, and the output layer 1030) included in the model 1000. For example, tuning of the model 1000 may be performed based on supervised learning and/or unsupervised learning.

For example, an electronic device may change policy information used by the model 1000 to control an agent based on an interaction between the agent and an environment. The policy information is a rule in which the electronic device determines an action of the agent within the environment using a neural network, and the electronic device may change the policy information of the neural network by training the neural network based on the interaction between the agent and the environment. For example, the policy information may be changed such that the agent determines an optimal action and/or a sequence of action for achieving an obtainable reward and/or a goal. According to an embodiment, the electronic device may cause a change in the policy information by the model 1000 to maximize the goal and/or the reward of the agent by the interaction.

The model 1000 may extract feature values from an inputted data and compare similarity between a vector (or an embedding vector) generated from the extracted feature values and a reference vector (or a reference embedding vector) stored within the electronic device 201. In accordance with a result of the comparison, identification information may be generated. The model 1000 may be trained via a loss function corresponding to a difference between ground truth and output data. For example, the loss function may include a softmax loss function, a Euclidean distance based loss function, or an angular based (or cosine margin based) loss function.

According to an embodiment, the model 1000 may need training data to train. For example, the training data may be referred to as a data set. The training data of the model 1000 may include a simulation image (or a video) including a virtual road. For example, the training data of the model 1000 may include simulation data including a virtual car. For example, by training the model 1000 using the simulation data, cost used for training the model 1000 may be reduced.

According to an embodiment, the simulation data may be used to train the model 1000 (e.g., the object detection model 311 or the image segmentation model 312). For example, the simulation data may include videos (or images) based on simulation. For example, a type of the virtual car, a height of an image sensor equipped with the virtual car, an angle of the image sensor equipped with the virtual car, an angle of view of the image sensor equipped with the virtual car, and/or resolution of an image obtained via the image sensor may differ for each of the videos based on the simulation. For example, the type of the virtual car may include a bus, a truck, a light car SUV, a VAN, a sedan, and a cargo truck. For example, the height of the image sensor equipped with the virtual car may have a value greater than 1.1 m and less than 2.0 m. For example, the angle of view of the image sensor equipped with the virtual car may have a value greater than 35° and less than 120°. For example, the resolution of the image may include 16:9 and 4:3.

According to an embodiment, the simulation data may be used to train the model 1000 (e.g., the object detection model 313). For example, the simulation data may include data necessary to project a 3 dimensional image into a 2 dimensional image. For example, the simulation data may include videos based on simulation. For example, a type of the virtual car, a height of an image sensor equipped with the virtual car, an angle of the image sensor equipped with the virtual car, an angle of view of the image sensor equipped with the virtual car, and/or resolution of an image obtained via the image sensor may differ for each of the videos based on the simulation. For example, the simulation data may include coordinate data of the virtual car within each of the videos based on the simulation. For example, the coordinate data of the virtual car may include a horizontal length of a bounding box corresponding to the virtual car, a vertical length of the bounding box, and a coordinate value of at least one vertex of the bounding box. For example, the simulation data may have a normalized value. For example, normalized simulation data may be indicated by a value between −2 and 2. For example, the normalization of the simulation data may be based on a size of resolution.

According to an embodiment, the simulation data may include movement direction data of the virtual car within each of the videos based on the simulation. For example, the movement direction data of the virtual car may be indicated as a value of applying a periodic function to a movement direction angle of the virtual car. For example, the periodic function may include a trigonometric function. For example, the periodic function may include a periodic function in a form of repeating that an output value increases linearly from −1 to 1 and decreases linearly from 1 to −1 as an input value increases. For example, a value of applying the periodic function to the movement direction angle of the virtual car may indicate similarity of the movement direction angle, since it has a value between −1 and 1 and has a relatively small difference for a substantially adjacent angle (e.g., 359° and 1°, which have a difference of 2°).

For example, the model 1000 (e.g., the direction identification model 313) of the electronic device 201 may enhance quality of the model 1000, since it may identify an exact movement direction angle of the virtual car in a case of learning using the simulation data. For example, quality of direction identification of the model 1000 learned using the simulation data may be higher than quality of direction identification of another model learned using data of an actual car.

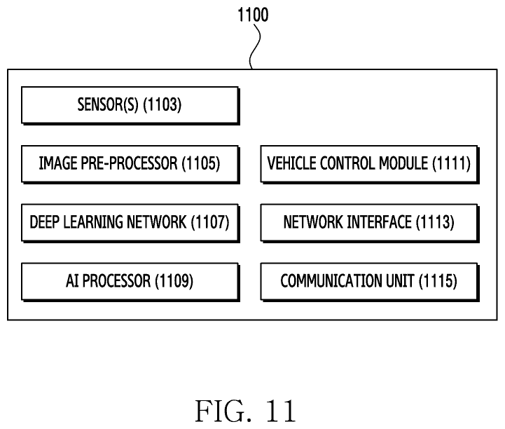

FIG. 11 illustrates an example of a block diagram illustrating an autonomous driving system of a vehicle according to an embodiment.

The autonomous driving system 1100 of the vehicle according to FIG. 11 may be a deep learning network including sensors 1103, an image pre-processor 1105, a deep learning network 1107, an artificial intelligence (AI) processor 1109, a vehicle control module 1111, a network interface 1113, and a communication unit 1115. In various embodiments, each element may be connected through various interfaces. For example, sensor data sensed and outputted by the sensors 1103 may be fed to the image pre-processor 1105. The sensor data processed by the image pre-processor 1105 may be fed to the deep learning network 1107 running on the AI processor 1109. An output of the deep learning network 1107 running by the AI processor 1109 may be fed to the vehicle control module 1111. Intermediate results of the deep learning network 1107 running on the AI processor 1109 may be fed to the AI processor 1109. In various embodiments, the network interface 1113 delivers autonomous driving route information and/or autonomous driving control commands for autonomous driving of the vehicle to internal block configurations, by performing communication with an electronic device (e.g., the electronic device 201) in the vehicle. In an embodiment, the network interface 1113 may be used to transmit the sensor data obtained through the sensor(s) 1103 to an external server. In some embodiments, the autonomous driving control system 1100 may include additional or fewer components as appropriate. For example, in some embodiments, the image pre-processor 1105 may be an optional component. For another example, a post-processing component (not illustrated) may be included in the autonomous driving control system 1100 to perform post-processing on the output of the deep learning network 1107 before the output is provided to the vehicle control module 1111.

In some embodiments, the sensors 1103 may include one or more sensors. In various embodiments, the sensors 1103 may be attached to different locations of the vehicle. The sensors 1103 may face one or more different directions. For example, the sensors 1103 may be attached to a front, sides, a rear, and/or a roof of the vehicle to face directions such as forward-facing, rear-facing, and side-facing. In some embodiments, the sensors 1103 may be image sensors such as high dynamic range cameras. In some embodiments, the sensors 1103 include non-visual sensors. In some embodiments, the sensors 1103 include RADAR, Light Detection And Ranging (LiDAR), and/or ultrasonic sensors in addition to an image sensor. In some embodiments, the sensors 1103 are not mounted on a vehicle having the vehicle control module 1111. For example, the sensors 1103 may be included as a portion of a deep learning system for capturing the sensor data and may be attached to an environment or a roadway and/or mounted on nearby vehicles.

In some embodiments, the image pre-processor 1105 may be used to pre-process the sensor data of the sensors 1103. For example, the image pre-processor 1105 may be used to preprocess the sensor data, to split the sensor data into one or more components, and/or to post-process one or more components. In some embodiments, the image pre-processor 1105 may be a graphics processing unit (GPU), a central processing unit (CPU), an image signal processor, or a specialized image processor. In various embodiments, the image pre-processor 1105 may be a tone-mapper processor for processing high dynamic range data. In some embodiments, the image pre-processor 1105 may be a component of the AI processor 1109.

In some embodiments, the deep learning network 1107 may be a deep learning network for implementing control commands for controlling an autonomous vehicle. For example, the deep learning network 1107 may be an artificial neural network such as a convolution neural network (CNN) trained by using the sensor data, and the output of the deep learning network 1107 is provided to the vehicle control module 1111.

In some embodiments, the artificial intelligence (AI) processor 1109 may be a hardware processor for running the deep learning network 1107. In some embodiments, the AI processor 1109 is a specialized AI processor for performing inference on the sensor data through the convolution neural network (CNN). In some embodiments, the AI processor 1109 may be optimized for a bit depth of the sensor data. In some embodiments, the AI processor 1109 may be optimized for deep learning computations, such as computations of a neural network including a convolution, a dot product, a vector and/or matrix computations. In some embodiments, the AI processor 1109 may be implemented through a plurality of graphics processing units (GPUs) capable of effectively performing parallel processing.

In various embodiments, the AI processor 1109 may be coupled, through an input/output interface, to memory configured to perform a deep learning analysis on the sensor data received from the sensor(s) 1103 while the AI processor 1109 is running and to provide an AI processor having commands that cause to determine a machine learning result used to operate the vehicle at least partially autonomously. In some embodiments, the vehicle control module 1111 may be used to process commands for vehicle control outputted from the artificial intelligence (AI) processor 1109 and translate the output of the AI processor 1109 into commands for controlling a module of each vehicle to control various modules of the vehicle. In some embodiments, the vehicle control module 1111 is used to control a vehicle for autonomous driving. In some embodiments, the vehicle control module 1111 may adjust steering and/or speed of the vehicle. For example, the vehicle control module 1111 may be used to control traveling of the vehicle such as deceleration, acceleration, steering, lane change, lane keeping, and the like. In some embodiments, the vehicle control module 1111 may generate control signals for controlling vehicle lighting, such as brake lights, turns signals, headlights, and the like. In some embodiments, the vehicle control module 1111 may be used to control vehicle audio-related systems such as a vehicle's sound system, vehicle's audio warnings, a vehicle's microphone system, a vehicle's horn system, and the like.

In some embodiments, the vehicle control module 1111 may be used to control notification systems, including warning systems to notify passengers and/or a driver of driving events, such as approach of an intended destination or a potential collision. In some embodiments, the vehicle control module 1111 may be used to adjust sensors, such as the sensors 1103 of the vehicle. For example, the vehicle control module 1111 may modify the orientation of the sensors 1103, change output resolution and/or a format type of the sensors 1103, increase or decrease a capture rate, adjust a dynamic range, and adjust a focus of the camera. In addition, the vehicle control module 1111 may turn on/off the operation of sensors individually or collectively.

In some embodiments, the vehicle control module 1111 may be used to change parameters of the image pre-processor 1105 in a method such as modifying a frequency range of filters, adjusting features and/or edge detection parameters for object detection, or adjusting channels and a bit depth, and the like. In various embodiments, the vehicle control module 1111 may be used to control autonomous driving of the vehicle and/or a driver assistance function of the vehicle.

In some embodiments, the network interface 1113 may be responsible for an internal interface between block configurations of the autonomous driving control system 1100 and the communication unit 1115. Specifically, the network interface 1113 may be a communication interface for receiving and/or transmitting data including voice data. According to various embodiments, the network interface 1113 may be connected to external servers to connect voice calls, receive and/or transmit text messages, transmit sensor data, update software of the vehicle with the autonomous driving system, or update software of the autonomous driving system of the vehicle, through the communication unit 1115.

In various embodiments, the communication unit 1115 may include various wireless interfaces of cellular or WiFi methods. For example, the network interface 1113 may be used to receive an update on operating parameters and/or commands for the sensors 1103, the image pre-processor 1105, the deep learning network 1107, the AI processor 1109, and the vehicle control module 1111 from an external server connected through the communication unit 1115. For example, a machine learning model of the deep learning network 1107 may be updated by using the communication unit 1115. According to another example, the communication unit 1115 may be used to update operating parameters of the image pre-processor 1105, such as image processing parameters, and/or firmware of the sensors 1103.

In another embodiment, the communication unit 1115 may be used to activate communications for an emergency contact and emergency services in an accident or near-accident event. For example, in a crash event, the communication unit 1115 may be used to call emergency services for assistance and may be used to externally notify emergency services of crash details and a location of the vehicle. In various embodiments, the communication unit 1115 may update or obtain an expected arrival time and/or a destination location.

According to an embodiment, the autonomous driving system 1100 illustrated in FIG. 11 may be configured with an electronic device 201 of the vehicle. According to an embodiment, when an autonomous driving release event occurs from a user during autonomous driving of the vehicle, the AI processor 1109 of the autonomous driving system 1100 may control the software of the vehicle autonomous driving to learn by controlling information related to the autonomous driving release event to be inputted as training set data of the deep learning network.

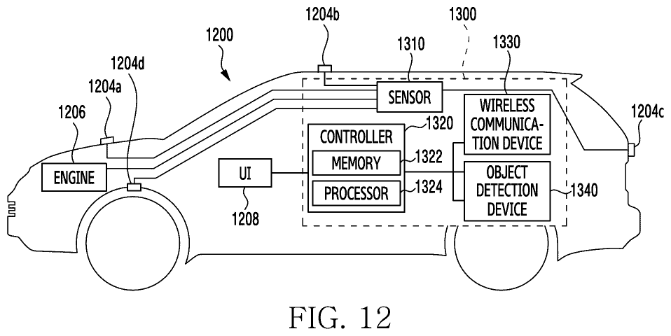

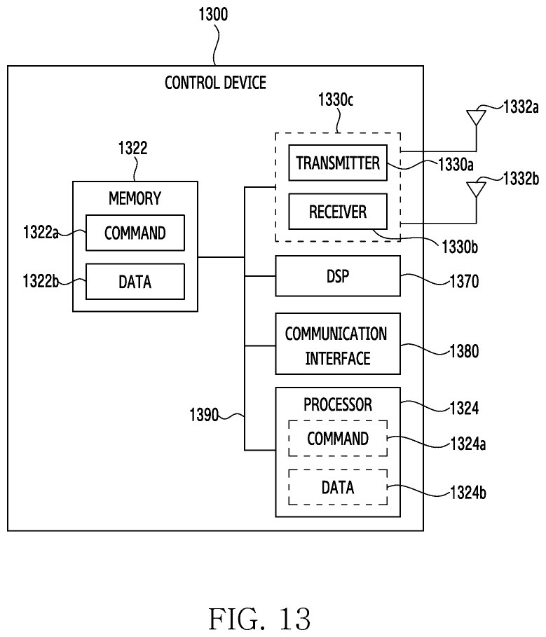

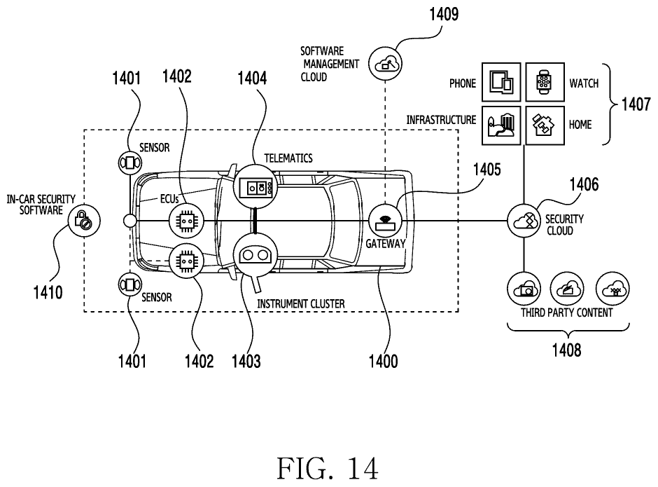

FIGS. 12 and 13 illustrate an example of a block diagram indicating an autonomous driving moving object according to an embodiment. FIG. 14 illustrates an example of a gateway related to a user device according to various embodiments.

Referring to FIG. 12, an autonomous moving object 1200 according to the present embodiment may include a control device 1300, sensing modules 1204a, 1204b, 1204c, and 1204d, an engine 1206, and a user interface 1208.

The autonomous driving moving object 1200 may have an autonomous driving mode or a manual mode. As an example, according to a user input received through the user interface 1208, it may be switched from the manual mode to the autonomous driving mode or may be switched from the autonomous driving mode to the manual mode.

In case that the moving object 1200 operates in the autonomous driving mode, the autonomous driving moving object 1200 may operate under control of the control device 1300.

In the present embodiment, the control device 1300 may include a controller 1320, including memory 1322 and a processor 1324, a sensor 1310, a communication device 1330, and an object detection device 1340.

Herein, the object detection device 1340 may perform all or a portion of a function of a distance measurement device.

That is, in the present embodiment, the object detection device 1340 is a device for detecting an object located outside the moving object 1200, and the object detection device 1340 may detect the object located outside the moving object 1200 and generate object information according to the detection result.

The object information may include information on existence or nonexistence of the object, location information of the object, distance information between the moving object and the object, and relative speed information between the moving object and the object.

The object may include various objects located outside the moving object 1200, such as a lane, another vehicle, a pedestrian, a traffic signal, light, a road, a structure, a speed bump, a landform, an animal, and the like. Herein, the traffic signal may be a concept including a traffic signal, a traffic sign, a pattern or text drawn on a road surface. In addition, the light may be light generated from a lamp equipped in another vehicle, light generated from a streetlamp, or sunlight.

In addition, the structure may be an object located around a road and fixed to the ground. For example, the structure may include a streetlamp, a street tree, a building, a power pole, a traffic light, and a bridge. The landform may include a mountain, a hill, and the like.

Such the object detection device 1340 may include a camera module. The controller 1320 may extract object information from an external image photographed by the camera module and enable the controller 1320 to process information thereon.

In addition, the object detection device 1340 may further include imaging devices for recognizing an external environment. RADAR, a GPS device, Odometry, and another computer vision device, an ultrasonic sensor, and an infrared sensor may be used, in addition to LIDAR, and these devices may be selected or operated simultaneously as needed to enable more precise detection.

Meanwhile, the distance measurement device according to an embodiment of the present invention may calculate a distance between the autonomous driving moving object 1200 and the object, and may control an operation of the moving object based on the distance calculated in connection with the control device 1300 of the autonomous driving moving object 1200.

As an example, in case that there is a probability of a collision according to the distance between the autonomous driving moving object 1200 and the object, the autonomous driving moving object 1200 may control a brake to lower a speed or stop. As another example, in case that the object is a moving object, the autonomous driving moving object 1200 may control a traveling speed of the autonomous driving moving object 1200 to maintain a predetermined distance or more from the object.

This distance measurement device according to an embodiment of the present invention may be configured as a module in the control device 1300 of the autonomous driving moving object 1200. That is, the memory 1322 and the processor 1324 of the control device 1300 may be configured to implement a collision prevention method according to the present invention in software.

In addition, the sensor 1310 may obtain various sensing information by connecting an internal/external environment of the moving object with the sensing modules 1204a, 1204b, 1204c, and 1204d. Herein, the sensor 1310 may include a posture sensor (e.g., a yaw sensor), a roll sensor, a pitch sensor, a collision sensor, a wheel sensor, a speed sensor, a tilt sensor, a weight detection sensor, a heading sensor, a gyro sensor, a position module, a moving object forward/rearward sensor, a battery sensor, a fuel sensor, a tire sensor, a steering sensor by handle rotation, a moving object internal temperature sensor, a moving object internal humidity sensor, an ultrasonic sensor, an illumination sensor, an accelerator pedal position sensor, a brake pedal position sensor, and the like.

Accordingly, the sensor 1310 may obtain sensing signals for moving object posture information, moving object collision information, moving object direction information, moving object location information (GPS information), moving object angle information, moving object speed information, moving object acceleration information, moving object tilt information, moving object forward/rearward information, battery information, fuel information, tire information, moving object lamp information, and moving object internal temperature information, moving object internal humidity information, a steering wheel rotation angle, moving object external illumination, a pressure applied to an accelerator pedal, a pressure applied to a brake pedal, and the like.

In addition, the sensor 1310 may further include an accelerator pedal sensor, a pressure sensor, an engine speed sensor, an air flow sensor (AFS), an intake air temperature sensor (ATS), a water temperature sensor (WTS), a throttle position sensor (TPS), a TDC sensor, a crank angle sensor (CAS), and the like.

As such, the sensor 1310 may generate moving object state information based on sensing data.

The wireless communication device 1330 is configured to implement wireless communication between the autonomous driving moving object 1200. For example, it enables the autonomous driving moving object 1200 to communicate with a mobile phone of a user, or the other wireless communication device 1330, another moving object, a central device (a traffic control device), a server, and the like. The wireless communication device 1330 may transmit and receive a wireless signal according to an access wireless protocol. A wireless communication protocol may be Wi-Fi, Bluetooth, Long-Term Evolution (LTE), Code Division Multiple Access (CDMA), Wideband Code Division Multiple Access (WCDMA), Global Systems for Mobile Communications (GSM), but the communication protocol is not limited thereto.

In addition, in the present embodiment, it is also possible for the autonomous driving moving object 1200 to implement communication between moving objects through the wireless communication device 1330. That is, the wireless communication device 1330 may perform communication with another moving object and other moving objects on the road through vehicle-to-vehicle (V2V) communication. The autonomous driving moving object 1200 may transmit and receive information such as driving warning and traffic information through the vehicle-to-vehicle (V2V) communication, and it is also possible to request information from, or receive a request from the other moving object. For example, the wireless communication device 1330 may perform the V2V communication as a dedicated short-range communication (DSRC) device or a Cellular-V2V (C-V2V) device. In addition, besides the vehicle-to-vehicle (V2V) communication, communication (e.g., Vehicle to Everything communication (V2X)) between a vehicle and another object (e.g., an electronic device carried by a pedestrian, and the like) may also be implemented through the wireless communication device 1330.

In addition, the wireless communication device 1330 may obtain information generated from various mobilities, including infrastructure (a traffic light, a CCTV, a RSU, a eNode B, and the like) located on the road or other autonomous driving/non-autonomous driving vehicles, and the like, through a non-terrestrial network other than a terrestrial network, as information for autonomous driving performance of the autonomous driving moving object 1200.

For example, the wireless communication device 1330 may perform wireless communication through a Low Earth Orbit (LEO) satellite system, a Medium Earth Orbit (MEO) satellite system, a Geostationary Orbit (GEO) satellite system, a High Altitude Platform (HAP) system, and the like, that configure a non-terrestrial network and an antenna dedicated to the non-terrestrial network mounted on the autonomous driving moving object 1200.

For example, the wireless communication device 1330 may perform wireless communication with various platforms configuring the NTN according to a 5TH Generation New Radio Non-Terrestrial Network (5G NR NTN) standard, which is currently discussed in 3GPP, and the like, but is not limited thereto.

In the present embodiment, the controller 1320 may select a platform that may properly perform NTN communication in consideration of various information such as a location of the autonomous driving moving object 1200, current time, and available power, and control the wireless communication device 1330 to perform wireless communication with the selected platform.

In the present embodiment, the controller 1320, which is a unit that controls an overall operation of each unit in the moving object 1200, may be configured by a manufacturer of the moving object when manufacturing or may be additionally configured to perform a function of autonomous driving after manufacturing. In addition, a configuration for performing a continuous additional function may be included through an upgrade of the controller 1320 configured when manufacturing. This controller 1320 may also be named an Electronic Control Unit (ECU).

The controller 1320 may collect various data from the connected sensor 1310, the object detection device 1340, the communication device 1330, and may transmit a control signal to the sensor 1310, the engine 1206, the user interface 1208, the communication device 1330, and the object detection device 1340 included in other components in the moving object based on the collected data. In addition, although not illustrated, the control signal may also be transmitted to an acceleration device, a braking system, a steering device, or a navigation device related to traveling of the moving object.

In the present embodiment, the controller 1320 may control the engine 1206, for example, may detects a speed limit of a road on which the autonomous driving moving object 1200 is traveling, and may control the engine 1206 so that a traveling speed does not exceed the speed limit or may control the engine 1206 to accelerate the traveling speed of the autonomous driving moving object 1200 in a range that does not exceed the speed limit.

In addition, when the autonomous driving moving object 1200 approaches a lane or leaves the lane while the autonomous driving moving object 1200 is traveling, the controller 1320 may determine whether such lane approaching and leaving are due to a normal traveling situation or another traveling situation, and may control the engine 1206 to control the traveling of the moving object according to the determination result. Specifically, the autonomous driving moving object 1200 may detect lanes formed on both sides of the lane in which the moving object is traveling. In this case, the controller 1320 may determine whether the autonomous driving moving object 1200 approaches the lane or leaves the lane, and if it is determined that the autonomous driving moving object 1200 approaches the lane or leaves the lane, the controller 1320 may determine whether this traveling is according to an accurate traveling situation or another traveling situation. Herein, as an example of the normal traveling situation, it may be a situation in which a lane change of the moving object is required. In addition, as an example of the other driving situations, it may be a situation in which a lane change of the moving object is not required. When it is determined that the autonomous driving moving object 1200 is approaching the lane or leaving the lane in a situation in which the moving object does not need to change lane, the controller 1320 may control the traveling of the autonomous driving moving object 1200 so that the autonomous driving moving object 1200 does not leave the lane and normally travels in a corresponding vehicle.

In case that another moving object or an obstacle exists in a front of the moving object, it may control the engine 1206 or the braking system to decelerate the driving moving object, and may control a trajectory, a traveling route, and a steering angle in addition to speed. Alternatively, the controller 1320 may control the traveling of the moving object by generating a necessary control signal according to recognition information of another external environment, such as a traveling lane or a driving signal of the moving object.

In addition to generating its own control signal, the controller 1320 may also control the traveling of the moving object by performing communication with a nearby moving object or a central server and transmitting a command to control peripheral devices through the received information.

In addition, since accurate recognition of the moving object or lane according to the present embodiment may be difficult in case that a location of the camera module changes or an angle of view changes, the controller 1320 may generate a control signal for controlling to perform calibration of the camera module to prevent this. Therefore, in the present embodiment, by generating the calibration control signal to the camera module, the controller 1320 may continuously maintain a normal mounting location, a direction, an angle of view, and the like of the camera module even when a mounting location of the camera module is changed due to vibration or impact generated by a movement of the autonomous driving moving object 1200. In case that an initial mounting location, a direction, and an angle of view information of the camera module that are pre-stored, and an initial mounting location, a direction, an angle of view information, and the like of the camera module measured while the autonomous driving moving object 800 is traveling are changed by a threshold value or more, the controller 1320 may generate the control signal to perform the calibration of the camera module.

In the present embodiment, the controller 1320 may include the memory 1322 and the processor 1324. The processor 1324 may execute software stored in the memory 1322 according to the control signal of the controller 1320. Specifically, the controller 1320 may store data and commands for performing the lane detection method according to the present invention in the memory 1322, and the commands may be executed by the processor 1324 to implement one or more methods disclosed herein.

In this case, the memory 1322 may be stored in a recording medium executable by the non-volatile processor 1324. The memory 1322 may store software and data through an appropriate internal/external device. The memory 1322 may be configured with random access memory (RAM), read only memory (ROM), a hard disk, and a memory 1322 device connected with a dongle.

The memory 1322 may at least store an Operating system (OS), a user application, and executable commands. The memory 1322 may also store application data and array data structures.

The processor 1324, which is a microprocessor or an appropriate electronic processor, may be a controller, a microcontroller, or a state machine.

The processor 1324 may be implemented as a combination of computing devices, and the computing device may be configured with a digital signal processor, a microprocessor, or an appropriate combination thereof.

Meanwhile, the autonomous driving moving object 1200 may further include the user interface 1208 for a user input with respect to the above-described control device 1300. The user interface 1208 may enable a user to input information with appropriate interaction. For example, it may be implemented as a touch screen, a keypad, or an operation button, and the like. The user interface 1208 may transmit an input or a command to the controller 1320, and the controller 1320 may perform a control operation of the moving object in response to the input or the command.

In addition, the user interface 1208, which is a device outside the autonomous driving moving object 1200, may perform communication with the autonomous driving moving object 1200 through the wireless communication device 1330. For example, the user interface 808 may be linkable with a mobile phone, a tablet, or another computer device.

Furthermore, in the present embodiment, the autonomous driving moving object 1200 has been described as including the engine 1206, but it may also include another type of a propulsion system. For example, the moving object may be operated with electrical energy, and may be operated through hydrogen energy or a hybrid system combining them. Therefore, the controller 1320 may include a propulsion mechanism according to the propulsion system of the autonomous driving moving object 1200 and may provide a control signal according to this to components of each propulsion mechanism.

Hereinafter, a detailed configuration of the control device 1300 according to the present invention according to the present embodiment will be described in more detail with reference to FIG. 13.

A control device 1300 includes a processor 1324. The processor 1324 may be a general-purpose single or multi-chip microprocessor, a dedicated microprocessor, a microcontroller, a programmable gate array, and the like. The processor may be referred to as a central processing unit (CPU). In addition, in the present embodiment, it is possible that the processor 1324 is used as a combination of a plurality of processors.

The control device 1300 also includes memory 1322. The memory 1322 may be any electronic component capable of storing electronic information. The memory 1322 may also include a combination of the memories 1322 in addition to single memory.

Data and commands 1322a for performing a distance measuring method of a distance measuring device according to the present invention may be stored in the memory 1322. When the processor 1324 executes the commands 1322a, all or a portion of the commands 1322a and the data 1322b required for performing a command may be loaded 1324a and 1324b onto the processor 1324.

The control device 1300 may include a transmitter 1330a, a receiver 1330b, or a transceiver 1330c for permitting transmission and reception of signals. One or more antennas 1332a and 1332b may be electrically connected to the transmitter 1330a, the receiver 1330b, or each transceiver 1330c, and may further include antennas.

The control device 1300 may include a digital signal processor (DSP) 1370. Through the DSP 1370, the digital signal may be quickly processed by a moving object.

The control device 1300 may include a communication interface 1380. The communication interface 1380 may include one or more ports and/or communication modules for connecting other devices to the control device 1300. The communication interface 1380 may enable a user and the control device 1300 to interact with each other.

Various configurations of the control device 1300 may be connected together by one or more buses 1390, and the buses 1390 may include a power bus, a control signal bus, a state signal bus, a data bus, and the like. Under a control of the processor 1324, configurations may transmit mutual information through the bus 1390 and perform a desired function.

Meanwhile, in various embodiments, the control device 1300 may be related to a gateway for communication with a security cloud. For example, referring to FIG. 14, the control device 1300 may be related to a gateway 1405 for providing information obtained from at least one of components 1401 to 1404 of a vehicle 1400 to a security cloud 1406. For example, the gateway 1405 may be included in the control device 1300. For another example, the gateway 1405 may be configured as a separate device in the vehicle 1400 that is distinguished from the control device 1300. The gateway 1405 connects a network in the vehicle 1400 secured by a software management cloud 1409, the security cloud 1406, and in-car security software 1410, having different networks, to enable communication.

For example, a component 1401 may be a sensor. For example, the sensor may be used to obtain information on at least one of a state of the vehicle 1400 or a state around the vehicle 1400. For example, the component 1401 may include a sensor 1310.

For example, a component 1402 may be electronic control units (ECUs). For example, the ECUs may be used for engine control, transmission control, airbag control, and tire pressure management.

For example, a component 1403 may be an instrument cluster. For example, the instrument cluster may mean a panel located in a front of a driver's seat among dashboards. For example, the instrument cluster may be configured to display information necessary for driving to a driver (or a passenger). For example, the instrument cluster may be used to display at least one of visual elements for indicating a revolutions per minute (or rotates per minute) (RPM) of the engine, visual elements for indicating a speed of the vehicle 1400, visual elements for indicating an amount of remaining fuel, visual elements for indicating a state of a gear, or visual elements for indicating information obtained through the component 1401.

For example, a component 1404 may be a telematics device. For example, the telematics device may mean a device that provides various mobile communication services, such as location information and safe driving in the vehicle 1400 by coupling wireless communication technology and global positioning system (GPS) technology. For example, the telematics device may be used to connect the vehicle 1400 with a driver, a cloud (e.g., the security cloud 1406), and/or a surrounding environment. For example, the telematics device may be configured to support high bandwidth and low latency for 5G NR-standard technology (e.g., V2X technology of the 5G NR, Non-Terrestrial Network (NTN) technology of the 5G NR). For example, the telematics device may be configured to support autonomous driving of the vehicle 1400.

For example, the gateway 1405 may be used to connect a network within the vehicle 1400, and the software management cloud 1409 and the secure cloud 1406, which are a network outside the vehicle. For example, the software management cloud 1409 may be used to update or manage at least one software necessary for traveling and managing the vehicle 1400. For example, the software management cloud 1409 may be linked to the in-car security software 1410 installed in the vehicle. For example, the in-car security software 1410 may be used to provide a security function in the vehicle 1400. For example, the in-car security software 1410 may encrypt data transmitted and received through an in-car network using an encryption key obtained from an external authorized server for encryption of the in-car network. In various embodiments, the encryption key used by the in-car security software 1410 may be generated corresponding to vehicle identification information (a vehicle license plate, a vehicle identification number (VIN)) or information (e.g., user identification information) uniquely assigned to each user.

In various embodiments, the gateway 1405 may transmit the data encrypted by the in-car security software 1410 based on the encryption key to the software management cloud 1409 and/or the security cloud 1406. The software management cloud 1409 and/or the security cloud 1406 may identify the data received from which vehicle or which user by decrypting the data encrypted by the encryption key of the in-car security software 1410. For example, since the decryption key is a unique key corresponding to the encryption key, the software management cloud 1409 and/or the security cloud 1406 may identify a transmission entity (e.g., the vehicle or the user) of the data based on the data decrypted through the decryption key.

For example, the gateway 1405 may be configured to support in-car security software 1410 and may be related to the control device 1300. For example, the gateway 1405 may be related to the control device 1300 to support a connection between a client device 1407 and the control device 1300 connected to the security cloud 1406. For another example, the gateway 1405 may be related to the control device 1300 to support a connection between a third-party cloud 1408 connected to the security cloud 1406 and the control device 1300. However, it is not limited thereto.

In various embodiments, the gateway 1405 may be used to connect the vehicle 1400 with the software management cloud 1409 to manage operating software of the vehicle 1400. For example, the software management cloud 1409 may monitor whether updating the operating software of the vehicle 1400 is required, and based on monitoring that the updating the operating software of the vehicle 1400 is required, provide data for the updating the operating software of the vehicle 1400 through the gateway 1405. For another example, the software management cloud 1409 may receive a user request for updating the operating software of the vehicle 1400 from the vehicle 1400 through the gateway 1405, and provide data for updating the operating software of the vehicle 1400 based on the reception. However, it is not limited thereto.

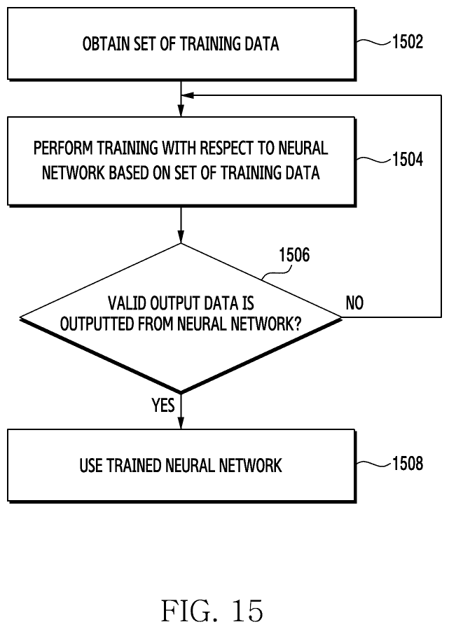

FIG. 15 is a diagram for explaining an operation of an electronic device for training a neural network based on a set of learning data, according to an embodiment.

An operation described with reference to FIG. 15 may be performed by the above-described electronic device (e.g., the electronic device 201 of FIG. 2).

Referring to FIG. 15, in operation 1502, the electronic device may obtain the set of the learning data according to an embodiment. The electronic device may obtain the set of the learning data for supervised learning. The learning data may include a pair of input data and ground truth data corresponding to the input data. The ground truth data may indicate output data to be obtained from the neural network that has received the input data, which is the pair of the ground truth data. The ground truth data may be obtained by the electronic device described above.

For example, in case of training the neural network for image recognition, the learning data may include information regarding an image and one or more subjects included within the image. The information may include a category (or a class) of a subject identifiable through the image. The information may include a location, a width, a height, and/or a size of a visual object corresponding to the subject within the image. The set of the learning data identified through the operation 1502 may include pairs of a plurality of learning data. In the example of training the neural network for the image recognition, the set of the learning data identified by the electronic device may include a plurality of images and ground truth data corresponding to each of the plurality of images.

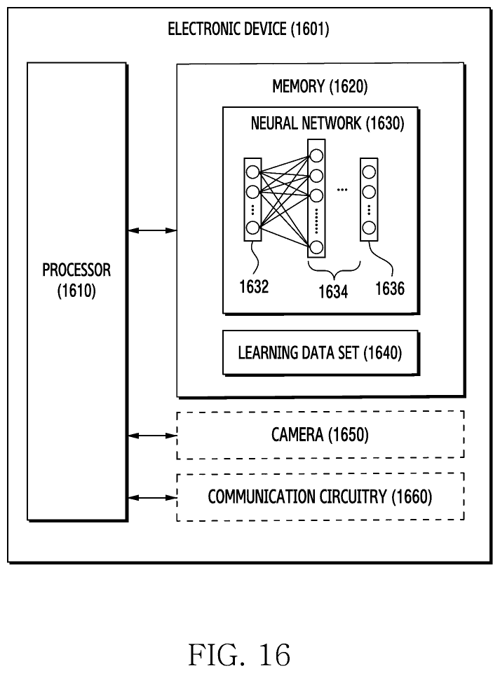

Referring to FIG. 15, in operation 1504, the electronic device according to an embodiment may perform training on the neural network based on the set of the learning data. In an embodiment in which the neural network is trained based on the supervised learning, the electronic device may input the input data included in the learning data to an input layer of the neural network. An example of the neural network including the input layer will be described with reference to FIG. 16. From an output layer of the neural network receiving the input data through the input layer, the electronic device may obtain output data of the neural network corresponding to the input data.

In an embodiment, the training of the operation 1504 may be performed based on a difference between the output data and the ground truth data included in the learning data and corresponding to the input data. For example, the electronic device may adjust one or more parameters related to the neural network (e.g., a weight to be described later with reference to FIG. 16) to reduce the difference based on a gradient descent algorithm. An operation of the electronic device adjusting the one or more parameters may be referred to as tuning for the neural network. The electronic device may perform the tuning of the neural network based on the output data using a function defined to evaluate performance of the neural network, such as a cost function. The difference between the output data and the ground truth data may be included as an example of the cost function.

Referring to FIG. 15, in operation 1506, according to an embodiment, the electronic device may identify whether valid output data is outputted from the neural network trained by the operation 1504. The output data being valid may mean that the difference (or the cost function) between the output data and the ground truth data satisfies a condition set for use of the neural network. For example, in case that an average value and/or the maximum value of the difference between the output data and the ground truth data is less than or equal to a designated threshold value, the electronic device may determine that the valid output data is outputted from the neural network.

In case that the valid output data is not outputted from the neural network (1506—NO), the electronic device may repeatedly perform training of the neural network based on the operation 1504. An embodiment is not limited thereto, and the electronic device may repeatedly perform the operations 1502 and 1504.

In a state in which the valid output data is obtained from the neural network (1506—YES), based on operation 1508, the electronic device according to an embodiment may use the trained neural network. For example, the electronic device may input other input data to the neural network that is distinct from the input data inputted to the neural network as the learning data. The electronic device may use output data obtained from the neural network receiving the other input data as a result of performing inference on the other input data based on the neural network.

FIG. 16 is a block diagram of an electronic device according to an embodiment.

An electronic device 1601 of FIG. 16 may include the above-described electronic device 201.

For example, an operation described with reference to FIG. 15 may be performed by the electronic device 1601 of FIG. 16 and/or a processor 1610 of FIG. 16.

Referring to FIG. 16, the processor 1610 of the electronic device 1601 may perform computations related to a neural network 1630 stored in memory 1620. The processor 1610 may include at least one of a center processing unit (CPU), a graphic processing unit (GPU), and a neural processing unit (NPU). The NPU may be implemented as a chip separated from the CPU, or integrated into a chip such as the CPU in a form of a system on a chip (SoC). The NPU integrated into the CPU may be referred to as a neural core and/or an artificial intelligence (AI) accelerator.

Referring to FIG. 16, the processor 1610 may identify the neural network 1630 stored in the memory 1620. The neural network 1630 may include a combination of an input layer 1632, one or more hidden layers 1634 (or intermediate layers), and an output layer 1636. The above-described layers (e.g., the input layer 1632, the one or more hidden layers 1634, and the output layer 1636) may include a plurality of nodes. The number of hidden layers 1634 may vary according to an embodiment, and the neural network 1630 including the plurality of hidden layers 1634 may be referred to as a deep neural network. An operation of training the deep neural network may be referred to as deep learning.

In an embodiment, in case that the neural network 1630 has a structure of a feed forward neural network, a first node included in a specific layer may be connected to all of second nodes included in another layer before the specific layer. In the memory 1620, parameters stored for the neural network 1630 may include weights assigned to connections between the second nodes and the first node. In the neural network 1630 having the structure of the feed forward neural network, a value of the first node may correspond to a weighted sum of values assigned to the second nodes, based on the weights assigned to the connections connecting the second nodes and the first node.

In an embodiment, in case that the neural network 1630 has a structure of a convolutional neural network, the first node included in the specific layer may correspond to a weighted sum of a portion of the second nodes included in the other layer before the specific layer. The portion of the second nodes corresponding to the first node may be identified by a filter corresponding to the specific layer. In the memory 1620, the parameters stored for the neural network 1630 may include weights indicating the filter. The filter may include, among the second nodes, one or more nodes to be used to calculate a weighted sum of the first node, and weights corresponding to each of the one or more nodes.

According to an embodiment, the processor 1610 of the electronic device 1601 may perform training on the neural network 1630 using a learning data set 1640 stored in the memory 1620. Based on the learning data set 1640, the processor 1610 may adjust one or more parameters stored in the memory 1620 for the neural network 1630 by performing the operation described with reference to FIG. 15.

According to an embodiment, the processor 1610 of the electronic device 1601 may perform object detection, object recognition, and/or object classification using the neural network 1630 trained based on the learning data set 1640. The processor 1610 may input an image (or a video) obtained through a camera 1650 into the input layer 1632 of the neural network 1630. Based on the input layer 1632 to which the image is inputted, the processor 1610 may obtain a set (e.g., the output data) of values of the nodes of the output layer 1636 by sequentially obtaining values of the nodes of the layers included in the neural network 1630. The output data may be used as a result of inferring information included in the image using the neural network 1630. An embodiment is not limited thereto, and the processor 1610 may input an image (or a video) obtained from an external electronic device connected to the electronic device 1601 through communication circuitry 1660 to the neural network 1630.

In an embodiment, the neural network 1630 trained to process an image may be used to identify a region corresponding to a subject within the image (object detection), and/or to identify a class of the subject represented within the image (object recognition and/or object classification). For example, the electronic device 1601 may segment the region corresponding to the subject within the image based on a quadrangle shape such as a bounding box, using the neural network 1630. For example, the electronic device 1601 may identify at least one class matching the subject among a plurality of designated classes using the neural network 1630.

As described above, an electronic device may comprise an image sensor. The electronic device may comprise a central processing unit (CPU). The electronic device may comprise a neural processing unit (NPU). The electronic device may comprise memory comprising one or more storage media storing instructions. The instructions, when executed by the CPU, may cause the electronic device to obtain, via the image sensor, an image. The instructions, when executed by the CPU, may cause the electronic device to execute an object detection model configured to detect an external object from the image, by controlling the NPU. The instructions, when executed by the CPU, may cause the electronic device to obtain, from the NPU, coordinate values indicating a portion of the image associated with the external object. The instructions, when executed by the CPU, may cause the electronic device to perform a plurality of calculations defining a direction identification model configured to identify a direction of movement of the external object based on the coordinate values, by controlling processing circuitry of the CPU. The instructions, when executed by the CPU, may cause the electronic device to, based on a direction of movement of the external object indicated by a result of the plurality of calculations, output a notification with respect to the direction of movement.

According to an embodiment, the instructions, when executed by the CPU, may cause the electronic device to, based on obtaining other coordinate values indicating another portion of the image in conjunction with the coordinate values indicating the portion of the image by executing the object detection model, obtain a first size of the portion and a second size of the another portion. The instructions, when executed by the CPU, may cause the electronic device to, based on obtaining the second size greater than the first size, refrain from performing the plurality of calculations based on the coordinate values, perform the plurality of calculations defining the direction identification model based on the other coordinate values, and based on a direction of movement of another external object corresponding to the another portion indicated by a result of the plurality of calculations performed based on the other coordinate values, output a notification with respect to a direction of movement of the another external object.

According to an embodiment, the instructions, when executed by the CPU, may cause the electronic device to obtain, from the NPU, first data with respect to a type of the external object and second data with respect to a type of the another external object. The instructions, when executed by the CPU, may cause the electronic device to, further based on the first data and the second data, refrain from performing the plurality of calculations based on the coordinate values, perform the plurality of calculations defining the direction identification model based on the other coordinate values, and based on a direction of movement of the another external object corresponding to the another portion indicated by a result of the plurality of calculations performed based on the other coordinate values, output a notification with respect to a direction of movement of the another external object.

According to an embodiment, the instructions, when executed by the CPU, may cause the electronic device to execute an image segmentation model configured to recognize, from the image, a lane on which a car equipped with the electronic device is positioned, by controlling the NPU. The instructions, when executed by the CPU, may cause the electronic device to identify, from the NPU, an area within the image corresponding to a lane on which the car is positioned. The instructions, when executed by the CPU, may cause the electronic device to, based on identifying, from the object detection model executed by the NPU, portions respectively corresponding to a plurality of external objects from the image, compare the portions and the area. The instructions, when executed by the CPU, may cause the electronic device to perform the plurality of calculations defining the direction identification model using coordinate values of a portion overlapping the area from among the portions, by controlling the processing circuitry of the CPU.

According to an embodiment, the instructions, when executed by the CPU, may cause the electronic device to execute an image segmentation model configured to recognize, from the image, a road on which a car equipped with the electronic device is positioned, by controlling the NPU. The instructions, when executed by the CPU, may cause the electronic device to identify, from the NPU, an area within the image, corresponding to a road on which the car is positioned, divided by a central line. The instructions, when executed by the CPU, may cause the electronic device to, based on identifying, from the object detection model executed by the NPU, portions respectively corresponding to a plurality of external objects from the image, compare the portions and the area. The instructions, when executed by the CPU, may cause the electronic device to refrain from performing the plurality of calculations defining the direction identification model using coordinate values of a portion that does not overlap the area from among the portions, by controlling the processing circuitry of the CPU. The instructions, when executed by the CPU, may cause the electronic device to perform the plurality of calculations defining the direction identification model using coordinate values of a portion overlapping the area from among the portions, by controlling the processing circuitry of the CPU.

According to an embodiment, the instructions, when executed by the CPU, may cause the electronic device to, based on a result of the plurality of calculations, obtain duration in which the plurality of calculations is performed by the processing circuitry of the CPU. The instructions, when executed by the CPU, may cause the electronic device to, based on another image obtained from the image sensor after obtaining the image, execute the object detection model using the another image, by controlling the NPU. The instructions, when executed by the CPU, may cause the electronic device to, based on identifying, from the NPU, portions of the another image respectively associated with a plurality of external objects, determine the number of the portions of the another image such that a plurality of calculations of the direction identification model associated with the another image is performed within the duration.

According to an embodiment, the instructions, when executed by the CPU, may cause the electronic device to, in accordance with determining that the number of the portions identified from the another image is greater than the determined number, select portions to be used for performing the plurality of calculations defining the direction identification model based on sizes of each of the portions, from among the portions identified from the another image.

According to an embodiment, the electronic device may comprise a speaker. The instructions, when executed by the CPU, may cause the electronic device to, based on the direction of movement of the external object indicated by the result of the plurality of calculations, determine a probability of collision between the external object and the car equipped with the electronic device. The instructions, when executed by the CPU, may cause the electronic device to, based on the probability of collision, output an audio notification via the speaker.

According to an embodiment, the electronic device may comprise a light emitting diode (LED). The instructions, when executed by the CPU, may cause the electronic device to, based on the direction of movement of the external object indicated by the result of the plurality of calculations, determine a probability of collision between the external object and the car equipped with the electronic device. The instructions, when executed by the CPU, may cause the electronic device to, based on the probability of collision, emit light via the LED.

According to an embodiment, the electronic device may comprise a display. The instructions, when executed by the CPU, may cause the electronic device to, based on the direction of movement of the external object indicated by the result of the plurality of calculations, determine a probability of collision between the external object and the car equipped with the electronic device. The instructions, when executed by the CPU, may cause the electronic device to, based on the probability of collision, display a screen including a warning content via the display.

As described above, a method performed by an electronic device with an image sensor, a central processing unit (CPU), and a neural processing unit (NPU) may comprise obtaining, via the image sensor, an image. The method may comprise executing an object detection model configured to detect an external object from the image, by controlling the NPU. The method may comprise obtaining, from the NPU, coordinate values indicating a portion of the image associated with the external object. The method may comprise performing a plurality of calculations defining a direction identification model configured to identify a direction of movement of the external object based on the coordinate values, by controlling processing circuitry of the CPU. The method may comprise, based on a direction of movement of the external object indicated by a result of the plurality of calculations, outputting a notification with respect to the direction of movement.

According to an embodiment, the method may comprise, based on obtaining other coordinate values indicating another portion of the image in conjunction with the coordinate values indicating the portion of the image by executing the object detection model, obtaining a first size of the portion and a second size of the another portion. The method may comprise, based on obtaining the second size greater than the first size, refraining from performing the plurality of calculations based on the coordinate values, performing the plurality of calculations defining the direction identification model based on the other coordinate values, and based on a direction of movement of another external object corresponding to the another portion indicated by a result of the plurality of calculations performed based on the other coordinate values, outputting a notification with respect to a direction of movement of the another external object.

According to an embodiment, the method may comprise obtaining, from the NPU, first data with respect to a type of the external object and second data with respect to a type of the another external object. The method may comprise, further based on the first data and the second data, refraining from performing the plurality of calculations based on the coordinate values, performing the plurality of calculations defining the direction identification model based on the other coordinate values, and based on a direction of movement of the another external object corresponding to the another portion indicated by a result of the plurality of calculations performed based on the other coordinate values, outputting a notification with respect to a direction of movement of the another external object.

According to an embodiment, the method may comprise executing an image segmentation model configured to recognize, from the image, a lane on which a car equipped with the electronic device is positioned, by controlling the NPU. The method may comprise identifying, from the NPU, an area within the image corresponding to a lane on which the car is positioned. The method may comprise, based on identifying, from the object detection model executed by the NPU, portions respectively corresponding to a plurality of external objects from the image, comparing the portions and the area. The method may comprise performing the plurality of calculations defining the direction identification model using coordinate values of a portion overlapping the area from among the portions, by controlling the processing circuitry of the CPU.

According an embodiment, the method may comprise executing an image segmentation model configured to recognize, from the image, a road on which a car equipped with the electronic device is positioned, by controlling the NPU. The method may comprise identifying, from the NPU, an area within the image, corresponding to a road on which the car is positioned, divided by a central line. The method may comprise, based on identifying, from the object detection model executed by the NPU, portions respectively corresponding to a plurality of external objects from the image, comparing the portions and the area. The method may comprise refraining from performing the plurality of calculations defining the direction identification model using coordinate values of a portion that does not overlap the area from among the portions, by controlling the processing circuitry of the CPU. The method may comprise performing the plurality of calculations defining the direction identification model using coordinate values of a portion overlapping the area from among the portions, by controlling the processing circuitry of the CPU.

According to an embodiment, the method may comprise, based on a result of the plurality of calculations, obtaining duration in which the plurality of calculations is performed by the processing circuitry of the CPU. The method may comprise, based on another image obtained from the image sensor after obtaining the image, executing the object detection model using the another image, by controlling the NPU. The method may comprise, based on identifying, from the NPU, portions of the another image respectively associated with a plurality of external objects, determining the number of the portions of the another image such that a plurality of calculations of the direction identification model associated with the another image is performed within the duration.

According to an embodiment, the method may comprise, in accordance with determining that the number of the portions identified from the another image is greater than the determined number, selecting portions to be used for performing the plurality of calculations defining the direction identification model based on sizes of each of the portions, from among the portions identified from the another image.

According to an embodiment, the electronic device may comprise a speaker. The method may comprise, based on the direction of movement of the external object indicated by the result of the plurality of calculations, determining a probability of collision between the external object and the car equipped with the electronic device. The method may comprise, based on the probability of collision, outputting an audio notification via the speaker.

According to an embodiment, the electronic device may comprise a light emitting diode (LED). The method may comprise, based on the direction of movement of the external object indicated by the result of the plurality of calculations, determining a probability of collision between the external object and the car equipped with the electronic device. The method may comprise, based on the probability of collision, emitting light via the LED.

According to an embodiment, the electronic device may comprise a display. The method may comprise, based on the direction of movement of the external object indicated by the result of the plurality of calculations, determining a probability of collision between the external object and the car equipped with the electronic device. The method may comprise, based on the probability of collision, displaying a screen including a warning content via the display.

As described above, in a computer readable storage medium storing one or more programs, the one or more programs may include instructions that, when executed by an electronic device with an image sensor, a CPU, and an NPU, cause the electronic device to obtain, via the image sensor, an image. The one or more programs may include instructions that, when executed by the electronic device, cause the electronic device to execute an object detection model configured to detect an external object from the image, by controlling the NPU. The one or more programs may include instructions that, when executed by the electronic device, cause the electronic device to obtain, from the NPU, coordinate values indicating a portion of the image associated with the external object. The one or more programs may include instructions that, when executed by the electronic device, cause the electronic device to perform a plurality of calculations defining a direction identification model configured to identify a direction of movement of the external object based on the coordinate values, by controlling processing circuitry of the CPU. The one or more programs may include instructions that, when executed by the electronic device, cause the electronic device to include, based on a direction of movement of the external object indicated by a result of the plurality of calculations, outputting a notification with respect to the direction of movement.

According to an embodiment, the one or more programs may include instructions that, when executed by the electronic device, cause the electronic device to, based on obtaining other coordinate values indicating another portion of the image in conjunction with the coordinate values indicating the portion of the image by executing the object detection model, obtain a first size of the portion and a second size of the another portion. The one or more programs may include instructions that, when executed by the electronic device, cause the electronic device to, based on obtaining the second size greater than the first size, refrain from performing the plurality of calculations based on the coordinate values, perform the plurality of calculations defining the direction identification model based on the other coordinate values, and based on a direction of movement of another external object corresponding to the another portion indicated by a result of the plurality of calculations performed based on the other coordinate values, output a notification with respect to a direction of movement of the another external object.

According to an embodiment, the one or more programs may include instructions that, when executed by the electronic device, cause the electronic device to obtain, from the NPU, first data with respect to a type of the external object and second data with respect to a type of the another external object. The one or more programs may include instructions that, when executed by the electronic device, cause the electronic device to, further based on the first data and the second data, refrain from performing the plurality of calculations based on the coordinate values, perform the plurality of calculations defining the direction identification model based on the other coordinate values, and based on a direction of movement of the another external object corresponding to the another portion indicated by a result of the plurality of calculations performed based on the other coordinate values, output a notification with respect to a direction of movement of the another external object.

According to an embodiment, the one or more programs may include instructions that, when executed by the electronic device, cause the electronic device to execute an image segmentation model configured to recognize, from the image, a lane on which a car equipped with the electronic device is positioned, by controlling the NPU. The one or more programs may include instructions that, when executed by the electronic device, cause the electronic device to identify, from the NPU, an area within the image corresponding to a lane on which the car is positioned. The one or more programs may include instructions that, when executed by the electronic device, cause the electronic device to, based on identifying, from the object detection model executed by the NPU, portions respectively corresponding to a plurality of external objects from the image, compare the portions and the area. The one or more programs may include instructions that, when executed by the electronic device, cause the electronic device to perform the plurality of calculations defining the direction identification model using coordinate values of a portion overlapping the area from among the portions, by controlling the processing circuitry of the CPU.

According to an embodiment, the one or more programs may include instructions that, when executed by the electronic device, cause the electronic device to execute an image segmentation model configured to recognize, from the image, a road on which a car equipped with the electronic device is positioned, by controlling the NPU. The one or more programs may include instructions that, when executed by the electronic device, cause the electronic device to identify, from the NPU, an area within the image, corresponding to a road on which the car is positioned, divided by a central line. The one or more programs may include instructions that, when executed by the electronic device, cause the electronic device to, based on identifying, from the object detection model executed by the NPU, portions respectively corresponding to a plurality of external objects from the image, compare the portions and the area. The one or more programs may include instructions that, when executed by the electronic device, cause the electronic device to refrain from performing the plurality of calculations defining the direction identification model using coordinate values of a portion that does not overlap the area from among the portions, by controlling the processing circuitry of the CPU. The one or more programs may include instructions that, when executed by the electronic device, cause the electronic device to perform the plurality of calculations defining the direction identification model using coordinate values of a portion overlapping the area from among the portions, by controlling the processing circuitry of the CPU.

According to an embodiment, the one or more programs may include instructions that, when executed by the electronic device, cause the electronic device to, based on a result of the plurality of calculations, obtain duration in which the plurality of calculations is performed by the processing circuitry of the CPU. The one or more programs may include instructions that, when executed by the electronic device, cause the electronic device to, based on another image obtained from the image sensor after obtaining the image, execute the object detection model using the another image, by controlling the NPU. The one or more programs may include instructions that, when executed by the electronic device, cause the electronic device to, based on identifying, from the NPU, portions of the another image respectively associated with a plurality of external objects, determine the number of the portions of the another image such that a plurality of calculations of the direction identification model associated with the another image is performed within the duration.

According to an embodiment, the one or more programs may include instructions that, when executed by the electronic device, cause the electronic device to, in accordance with determining that the number of the portions identified from the another image is greater than the determined number, select portions to be used for performing the plurality of calculations defining the direction identification model based on sizes of each of the portions, from among the portions identified from the another image.

According to an embodiment, the electronic device may comprise a speaker. The one or more programs may include instructions that, when executed by the electronic device, cause the electronic device to, based on the direction of movement of the external object indicated by the result of the plurality of calculations, determine a probability of collision between the external object and the car equipped with the electronic device. The one or more programs may include instructions that, when executed by the electronic device, cause the electronic device to, based on the probability of collision, output an audio notification via the speaker.

According to an embodiment, the electronic device may comprise a light emitting diode (LED). The one or more programs may include instructions that, when executed by the electronic device, cause the electronic device to, based on the direction of movement of the external object indicated by the result of the plurality of calculations, determine a probability of collision between the external object and the car equipped with the electronic device. The one or more programs may include instructions that, when executed by the electronic device, based on the probability of collision, emitting light via the LED.

According to an embodiment, the electronic device may comprise a display. The one or more programs may include instructions that, when executed by the electronic device, cause the electronic device to, based on the direction of movement of the external object indicated by the result of the plurality of calculations, determine a probability of collision between the external object and the car equipped with the electronic device. The one or more programs may include instructions that, when executed by the electronic device, cause the electronic device to, based on the probability of collision, display a screen including a warning content via the display.

As described above, an electronic device may comprise an image sensor. The electronic device may comprise a central processing unit (CPU). The electronic device may comprise a neural processing unit (NPU). The electronic device may comprise memory comprising one or more storage media storing instructions. The instructions, when executed by the CPU, may cause the electronic device to obtain, via the image sensor, an image. The instructions, when executed by the CPU, may cause the electronic device to execute an object detection model configured to detect an external object from the image, by controlling the NPU. The instructions, when executed by the CPU, may cause the electronic device to obtain, from the NPU, coordinate values indicating a portion of the image associated with the external object. The instructions, when executed by the CPU, may cause the electronic device to perform a plurality of calculations defining a direction identification model configured to identify a direction of movement of the external object based on the coordinate values, by controlling processing circuitry of the CPU. The instructions, when executed by the CPU, may cause the electronic device to, based on the coordinate values and a direction of movement of the external object indicated by a result of the plurality of calculations, output a notification with respect to a distance between a car equipped with the electronic device and the external object.

According to an embodiment, the instructions, when executed by the CPU, may cause the electronic device to obtain, from the NPU, data with respect to a type of the external object. The instructions, when executed by the CPU, may cause the electronic device to, further based on the data, output the notification with respect to the distance between the car equipped with the electronic device and the external object.

According to an embodiment, the electronic may comprise a speaker. The instructions, when executed by the CPU, may cause the electronic device to, based on the distance and the direction of movement of the external object indicated by the result of the plurality of calculations, determine a probability of collision between the external object and the car equipped with the electronic device. The instructions, when executed by the CPU, may cause the electronic device to, based on the probability of collision, output an audio notification via the speaker.

According to an embodiment, the electronic device may comprise a light emitting diode (LED). The instructions, when executed by the CPU, may cause the electronic device to, based on the distance and the direction of movement of the external object indicated by the result of the plurality of calculations, determine a probability of collision between the external object and the car equipped with the electronic device. The instructions, when executed by the CPU, may cause the electronic device to, based on the probability of collision, emit light via the LED.

According to an embodiment, the electronic device may comprise a display. The instructions, when executed by the CPU, may cause the electronic device to, based on the distance and the direction of movement of the external object indicated by the result of the plurality of calculations, determine a probability of collision between the external object and the car equipped with the electronic device. The instructions, when executed by the CPU, may cause the electronic device to, based on the probability of collision, display a screen including a warning content via the display.

As described above, a method performed by an electronic device with an image sensor, a CPU, and an NPU, may comprise obtaining, via the image sensor, an image. The method may comprise executing an object detection model configured to detect an external object from the image, by controlling the NPU. The method may comprise obtaining, from the NPU, coordinate values indicating a portion of the image associated with the external object. The method may comprise performing a plurality of calculations defining a direction identification model configured to identify a direction of movement of the external object based on the coordinate values, by controlling processing circuitry of the CPU. The method may comprise, based on the coordinate values and a direction of movement of the external object indicated by a result of the plurality of calculations, outputting a notification with respect to a distance between a car equipped with the electronic device and the external object.

According to an embodiment, the method may comprise obtaining, from the NPU, data with respect to a type of the external object. The method may comprise, further based on the data, outputting the notification with respect to the distance between the car equipped with the electronic device and the external object.

According to an embodiment, the electronic may comprise a speaker. The method may comprise, based on the distance and the direction of movement of the external object indicated by the result of the plurality of calculations, determining a probability of collision between the external object and the car equipped with the electronic device. The method may comprise, based on the probability of collision, outputting an audio notification via the speaker.

According to an embodiment, the electronic device may comprise a light emitting diode (LED). The method may comprise, based on the distance and the direction of movement of the external object indicated by the result of the plurality of calculations, determining a probability of collision between the external object and the car equipped with the electronic device. The method may comprise, based on the probability of collision, emitting light via the LED.

According to an embodiment, the electronic device may comprise a display. The method may comprise, based on the distance and the direction of movement of the external object indicated by the result of the plurality of calculations, determining a probability of collision between the external object and the car equipped with the electronic device. The method may comprise, based on the probability of collision, displaying a screen including a warning content via the display.

As described above, in a computer readable storage medium storing one or more programs, the one or more programs may include instructions that, when executed by an electronic device with an image sensor, a CPU, and an NPU, cause the electronic device to obtain, via the image sensor, an image. The one or more programs may include instructions that, when executed by the electronic device, cause the electronic device to execute an object detection model configured to detect an external object from the image, by controlling the NPU. The one or more programs may include instructions that, when executed by the electronic device, cause the electronic device to obtain, from the NPU, coordinate values indicating a portion of the image associated with the external object. The one or more programs may include instructions that, when executed by the electronic device, cause the electronic device to perform a plurality of calculations defining a direction identification model configured to identify a direction of movement of the external object based on the coordinate values, by controlling processing circuitry of the CPU. The one or more programs may include instructions that, when executed by the electronic device, cause the electronic device to, based on the coordinate values and a direction of movement of the external object indicated by a result of the plurality of calculations, output a notification with respect to a distance between a car equipped with the electronic device and the external object.

According to an embodiment, the one or more programs may include instructions that, when executed by the electronic device, cause the electronic device to obtain, from the NPU, data with respect to a type of the external object. The one or more programs may include instructions that, when executed by the electronic device, cause the electronic device to, further based on the data, output the notification with respect to the distance between the car equipped with the electronic device and the external object.

According to an embodiment, the electronic may comprise a speaker. The one or more programs may include instructions that, when executed by the electronic device, cause the electronic device to, based on the distance and the direction of movement of the external object indicated by the result of the plurality of calculations, determine a probability of collision between the external object and the car equipped with the electronic device. The one or more programs may include instructions that, when executed by the electronic device, cause the electronic device to, based on the probability of collision, output an audio notification via the speaker.

According to an embodiment, the electronic device may comprise a light emitting diode (LED). The one or more programs may include instructions that, when executed by the electronic device, cause the electronic device to, based on the distance and the direction of movement of the external object indicated by the result of the plurality of calculations, determine a probability of collision between the external object and the car equipped with the electronic device. The one or more programs may include instructions that, when executed by the electronic device, cause the electronic device to, based on the probability of collision, emit light via the LED.

According to an embodiment, the electronic device may comprise a display. The one or more programs may include instructions that, when executed by the electronic device, cause the electronic device to, based on the distance and the direction of movement of the external object indicated by the result of the plurality of calculations, determine a probability of collision between the external object and the car equipped with the electronic device. The one or more programs may include instructions that, when executed by the electronic device, cause the electronic device to, based on the probability of collision, display a screen including a warning content via the display.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved. Therefore, other implementations, other embodiments, and those equivalent to the scope of the claims are in the scope of the claims described later.

Methods according to embodiments described in claims or specifications of the present disclosure may be implemented as a form of hardware, software, or a combination of hardware and software.

In a case of implementing as software, a computer-readable storage medium for storing one or more programs (software module) may be provided. The one or more programs stored in the computer-readable storage medium are configured for execution by one or more processors in an electronic device. The one or more programs include instructions that cause the electronic device to execute the methods according to embodiments described in claims or specifications of the present disclosure. The one or more programs may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. In the case of being distributed online, at least part of the computer program product may be temporarily generated or at least temporarily stored in the machine-readable storage medium, such as memory of the manufacturer's server, the application store's server, or a relay server.

Such a program (software module, software) may be stored in a random access memory, a non-volatile memory including a flash memory, a read only memory (ROM), an electrically erasable programmable read only memory (EEPROM), a magnetic disc storage device, a compact disc-ROM (CD-ROM), an optical storage device (digital versatile discs (DVDs) or other formats), or a magnetic cassette. Alternatively, it may be stored in memory configured with a combination of some or all of them. In addition, a plurality of configuration memories may be included.

Additionally, a program may be stored in an attachable storage device that may be accessed through a communication network such as the Internet, Intranet, local area network (LAN), wide area network (WAN), or storage area network (SAN), or a combination thereof. Such a storage device may be connected to a device performing an embodiment of the present disclosure through an external port. In addition, a separate storage device on the communication network may also be connected to a device performing an embodiment of the present disclosure.

In the above-described specific embodiments of the present disclosure, components included in the disclosure are expressed in the singular or plural according to the presented specific embodiment. However, the singular or plural expression is selected appropriately according to a situation presented for convenience of explanation, and the present disclosure is not limited to the singular or plural component, and even components expressed in the plural may be configured in the singular, or a component expressed in the singular may be configured in the plural.

According to various embodiments, one or more components or operations of the above-described components may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be executed sequentially, in parallel, repeatedly, or heuristically, or one or more of the operations may be executed in a different order or omitted, or one or more other operations may be added.

Meanwhile, specific embodiments have been described in the detailed description of the present disclosure, and of course, various modifications are possible without departing from the scope of the present disclosure.

1. An electronic device comprising:
an image sensor;
a central processing unit (CPU);
a neural processing unit (NPU); and
memory comprising one or more storage media storing instructions that, when executed by the CPU, cause the electronic device to:
obtain, via the image sensor, an image,
execute an object detection model configured to detect an external object from the image, by controlling the NPU,
obtain, from the NPU, coordinate values indicating a portion of the image associated with the external object,
perform a plurality of calculations defining a direction identification model configured to identify a direction of movement of the external object based on the coordinate values, by controlling processing circuitry of the CPU, and
based on a direction of movement of the external object indicated by a result of the plurality of calculations, output a notification with respect to the direction of movement.

2. The electronic device of claim 1, wherein the instructions, when executed by the CPU, cause the electronic device to:
based on obtaining other coordinate values indicating another portion of the image in conjunction with the coordinate values indicating the portion of the image by executing the object detection model, obtain a first size of the portion and a second size of the another portion, and
based on obtaining the second size greater than the first size:
refrain from performing the plurality of calculations based on the coordinate values,
perform the plurality of calculations defining the direction identification model based on the other coordinate values, and
based on a direction of movement of another external object corresponding to the another portion indicated by a result of the plurality of calculations performed based on the other coordinate values, output a notification with respect to a direction of movement of the another external object.

3. The electronic device of claim 2, wherein the instructions, when executed by the CPU, cause the electronic device to:
obtain, from the NPU, first data with respect to a type of the external object and second data with respect to a type of the another external object, and
further based on the first data and the second data:
refrain from performing the plurality of calculations based on the coordinate values,
perform the plurality of calculations defining the direction identification model based on the other coordinate values, and
based on a direction of movement of the another external object corresponding to the another portion indicated by a result of the plurality of calculations performed based on the other coordinate values, output a notification with respect to a direction of movement of the another external object.

4. The electronic device of claim 1, wherein the instructions, when executed by the CPU, cause the electronic device to:
execute an image segmentation model configured to recognize, from the image, a lane on which a car equipped with the electronic device is positioned, by controlling the NPU,
identify, from the NPU, an area within the image corresponding to a lane on which the car is positioned,
based on identifying, from the object detection model executed by the NPU, portions respectively corresponding to a plurality of external objects from the image, compare the portions and the area, and
perform the plurality of calculations defining the direction identification model using coordinate values of a portion overlapping the area from among the portions, by controlling the processing circuitry of the CPU.

5. The electronic device of claim 1, wherein the instructions, when executed by the CPU, cause the electronic device to:
execute an image segmentation model configured to recognize, from the image, a road on which a car equipped with the electronic device is positioned, by controlling the NPU,
identify, from the NPU, an area within the image, corresponding to a road on which the car is positioned, divided by a central line,
based on identifying, from the object detection model executed by the NPU, portions respectively corresponding to a plurality of external objects from the image, compare the portions and the area,
refrain from performing the plurality of calculations defining the direction identification model using coordinate values of a portion that does not overlap the area from among the portions, by controlling the processing circuitry of the CPU, and
perform the plurality of calculations defining the direction identification model using coordinate values of a portion overlapping the area from among the portions, by controlling the processing circuitry of the CPU.

6. The electronic device of claim 1, wherein the instructions, when executed by the CPU, cause the electronic device to:
based on a result of the plurality of calculations, obtain duration in which the plurality of calculations is performed by the processing circuitry of the CPU,
based on another image obtained from the image sensor after obtaining the image, execute the object detection model using the another image, by controlling the NPU, and
based on identifying, from the NPU, portions of the another image respectively associated with a plurality of external objects, determine the number of the portions of the another image such that a plurality of calculations of the direction identification model associated with the another image is performed within the duration.

7. The electronic device of claim 6, wherein the instructions, when executed by the CPU, cause the electronic device to:
in accordance with determining that the number of the portions identified from the another image is greater than the determined number, select portions to be used for performing the plurality of calculations defining the direction identification model based on sizes of each of the portions, from among the portions identified from the another image.

8. The electronic device of claim 1, further comprising:
a speaker,
wherein the instructions, when executed by the CPU, cause the electronic device to:
based on the direction of movement of the external object indicated by the result of the plurality of calculations, determine a probability of collision between the external object and a car equipped with the electronic device, and
based on the probability of collision, output an audio notification via the speaker.

9. The electronic device of claim 1, further comprising:
a light emitting diode (LED),
wherein the instructions, when executed by the CPU, cause the electronic device to:
based on the direction of movement of the external object indicated by the result of the plurality of calculations, determine a probability of collision between the external object and a car equipped with the electronic device, and
based on the probability of collision, emit light via the LED.

10. The electronic device of claim 1, further comprising:
a display,
wherein the instructions, when executed by the CPU, cause the electronic device to:
based on the direction of movement of the external object indicated by the result of the plurality of calculations, determine a probability of collision between the external object and a car equipped with the electronic device, and
based on the probability of collision, display a screen including a warning content via the display.

11. An electronic device comprising:
an image sensor;
a central processing unit (CPU);
a neural processing unit (NPU); and
memory comprising one or more storage media storing instructions that, when executed by the CPU, cause the electronic device to:
obtain, via the image sensor, an image,
execute an object detection model configured to detect an external object from the image, by controlling the NPU,
obtain, from the NPU, coordinate values indicating a portion of the image associated with the external object,
perform a plurality of calculations defining a direction identification model configured to identify a direction of movement of the external object based on the coordinate values, by controlling processing circuitry of the CPU, and
based on the coordinate values and a direction of movement of the external object indicated by a result of the plurality of calculations, output a notification with respect to a distance between a car equipped with the electronic device and the external object.

12. The electronic device of claim 11, wherein the instructions, when executed by the CPU, cause the electronic device to:
obtain, from the NPU, data with respect to a type of the external object, and
further based on the data, output the notification with respect to the distance between the car equipped with the electronic device and the external object.

13. The electronic device of claim 11, further comprising:
a speaker,
wherein the instructions, when executed by the CPU, cause the electronic device to:
based on the distance and the direction of movement of the external object indicated by the result of the plurality of calculations, determine a probability of collision between the external object and the car equipped with the electronic device, and
based on the probability of collision, output an audio notification via the speaker.

14. The electronic device of claim 11, further comprising:
a light emitting diode (LED),
wherein the instructions, when executed by the CPU, cause the electronic device to:
based on the distance and the direction of movement of the external object indicated by the result of the plurality of calculations, determine a probability of collision between the external object and the car equipped with the electronic device, and
based on the probability of collision, emit light via the LED.

15. The electronic device of claim 11, further comprising:
a display,
wherein the instructions, when executed by the CPU, cause the electronic device to:
based on the distance and the direction of movement of the external object indicated by the result of the plurality of calculations, determine a probability of collision between the external object and the car equipped with the electronic device, and
based on the probability of collision, display a screen including a warning content via the display.

16. A non-transitory computer-readable storage medium storing one or more programs, the one or more programs including instructions that, when executed by an electronic device with an image sensor, a CPU, and an NPU, cause the electronic device to:
obtain, via the image sensor, an image,
execute an object detection model configured to detect an external object from the image, by controlling the NPU,
obtain, from the NPU, coordinate values indicating a portion of the image associated with the external object,
perform a plurality of calculations defining a direction identification model configured to identify a direction of movement of the external object based on the coordinate values, by controlling processing circuitry of the CPU, and
based on a direction of movement of the external object indicated by a result of the plurality of calculations, output a notification with respect to the direction of movement.

17. The non-transitory computer readable storage medium of claim 16,
wherein the one or more programs includes instructions that, when executed by the electronic device, cause the electronic device to:
based on obtaining other coordinate values indicating another portion of the image in conjunction with the coordinate values indicating the portion of the image by executing the object detection model, obtain a first size of the portion and a second size of the another portion, and
based on obtaining the second size greater than the first size:
refrain from performing the plurality of calculations based on the coordinate values,
perform the plurality of calculations defining the direction identification model based on the other coordinate values, and
based on a direction of movement of another external object corresponding to the another portion indicated by a result of the plurality of calculations performed based on the other coordinate values, output a notification with respect to a direction of movement of the another external object.

18. The non-transitory computer readable storage medium of claim 17,
wherein the one or more programs includes instructions that, when executed by the electronic device, cause the electronic device to:
obtain, from the NPU, first data with respect to a type of the external object and second data with respect to a type of the another external object, and
further based on the first data and the second data:
refrain from performing the plurality of calculations based on the coordinate values,
perform the plurality of calculations defining the direction identification model based on the other coordinate values, and
based on a direction of movement of the another external object corresponding to the another portion indicated by a result of the plurality of calculations performed based on the other coordinate values, output a notification with respect to a direction of movement of the another external object.

19. The non-transitory computer readable storage medium of claim 16,
wherein the one or more programs includes instructions that, when executed by the electronic device, cause the electronic device to:
execute an image segmentation model configured to recognize, from the image, a lane on which a car equipped with the electronic device is positioned, by controlling the NPU,
identify, from the NPU, an area within the image corresponding to a lane on which the car is positioned,
based on identifying, from the object detection model executed by the NPU, portions respectively corresponding to a plurality of external objects from the image, compare the portions and the area, and
perform the plurality of calculations defining the direction identification model using coordinate values of a portion overlapping the area from among the portions, by controlling the processing circuitry of the CPU.

20. The non-transitory computer readable storage medium of claim 16,
wherein the one or more programs includes instructions that, when executed by the electronic device, cause the electronic device to:
execute an image segmentation model configured to recognize, from the image, a road on which a car equipped with the electronic device is positioned, by controlling the NPU,
identify, from the NPU, an area within the image, corresponding to a road on which the car is positioned, divided by a central line,
based on identifying, from the object detection model executed by the NPU, portions respectively corresponding to a plurality of external objects from the image, compare the portions and the area,
refrain from performing the plurality of calculations defining the direction identification model using coordinate values of a portion that does not overlap the area from among the portions, by controlling the processing circuitry of the CPU, and
perform the plurality of calculations defining the direction identification model using coordinate values of a portion overlapping the area from among the portions, by controlling the processing circuitry of the CPU.
